(19) United States
(12) Patent Application Publication
(10) Pub. No.: US 2007/0050197 A1
(43) Pub. Date: Mar. 1, 2007

(54) System and method of interacting with hotel information and services

(76) Inventors: Edward Efron, Las Vegas, NV (US); Matthew Palumbo, White Plains, NY (US)

Correspondence Address: PILLSBURY WINTHROP SHAW PITTMAN, LLP, P.O. BOX 10500, MCLEAN, VA, 22102, US

(21) Appl. No.: 11/321,462

(22) Filed: Dec. 30, 2005

Related U.S. Application Data
(60) Provisional application No. 60/691,264, filed on Jun. 17, 2005.

(51) Int. Cl. G06Q 99/00

(52) U.S. Cl. 705/1; 705/5

(57) ABSTRACT

An automated system and method are provided for interacting with hotel information and hotel services using client terminal devices. The client terminal devices may be located in hotel guest rooms, at the front desk, or in public areas throughout the hotel. The user may be automatically authenticated or the user may be prompted to enter authentication information. Upon authentication, the user is provided with a plurality of icons for obtaining information regarding accounting services, scheduling a banquet, concierge services, engineering services, front desk services, general manager services, housekeeping services, meeting room services, restaurant services, room service, security services, wake-up call services, outside call services, dial a guest services, guest services, or other services.

This application claims priority to U.S. Provisional Application Ser. No. 60/691,264, filed Jun. 17, 2005, the entire contents of which is incorporated herein by reference.

### FIELD OF THE INVENTION

The invention is directed to automated systems and methods of interacting with hotel information and hotel services. More particularly, the invention provides client terminal devices that display graphical user interfaces for interacting with hotel information and hotel services.

### BACKGROUND OF THE INVENTION

Currently, the hotel industry relies heavily on front desk attendants to interact with hotel guests, such as responding to information and service requests. During busy times, telephone calls that are placed to the front desk may result in several rings before the attendant answers the telephone call, if at all. After pickup, hotel guests may be placed on hold for several minutes before finally speaking with the front desk attendant. Depending on the nature of the request, front desk attendants may need to transfer a hotel guest to other knowledge sources, such as a concierge, a room service representative, or a housekeeping representative. After the transfer, the telephone may ring several more times before the telephone call is answered. Alternatively, the telephone call may be forwarded to a voice message service where the caller is requested to leave a detailed voice message. Other drawbacks exist.

One conventional system attempts to alleviate the burden on front desk attendants by offering a plurality of quick dial buttons on the telephone that are separately labeled for the front desk attendants, concierge, room service, and housekeeping. Upon pressing a desired button, the telephone call is routed directly to the selected party. While this system may alleviate some of the delays and problems associated with telephone calls that would otherwise be directed to the front desk attendant, hotel guests may still be inconvenienced. For example, during busy times, telephone calls that are placed using these quick dial buttons may result in several rings before the telephone call is answered. After pickup, hotel guests may be asked to wait on hold before finally speaking with the appropriate person. Alternatively, the telephone call may be forwarded to a voice message service.

As the foregoing makes apparent, while a plurality of quick dial buttons permits a guest to call a hotel staff person without the need to look up an extension, quick dial buttons do not offer a flexible capability to address guest needs where a telephone connection may not be adequate.

Various other drawbacks exist with this system and with others known in the prior art.

### SUMMARY OF THE INVENTION

Various aspects of the invention overcome at least some of these and other drawbacks of existing systems. According to one embodiment, an automated system is provided that includes a plurality of client terminal devices, each of which may be connected to one or more other client terminal devices and/or servers via a wired, wireless, and/or a combination of wired and wireless connections and/or one or more networks including a wired network, a wireless network, a combination of wired and wireless networks or other networks.

Each client terminals device may include at least a processor, a memory, a display, and at least one input mechanism (e.g., a mouse or other input mechanism). A memory may be provided to locally store information on the client terminal device. Software may reside on the client terminal device, as desired. The software has various purposes and may be part of a single program or a collection of related components that operate together. In some cases, not all software will need to be used or are desired to be used. The software is purposefully designed to be flexible to permit features to be added and/or removed.

A user interface may be provided to enable users to interact with the software and to provide display information, tools and other options to users.

The client terminal devices also may include an authentication feature that requests user credentials and validates users as registered hotel guests, hotel employees, or otherwise as registered users. A presence feature further may be included to determine availability information about client terminal devices.

According to one embodiment, the invention provides client terminal devices having software for interacting with hotel information and hotel services. Hotel information may include banquet scheduling information, concierge information, engineer information, front desk information, general manager information, housekeeping information, meeting room information, restaurant information, room service information, security information, wake up call information, telephone call information, hotel guest information, local events information, Internet access information and/or other information. Hotel services may include accounting services, housekeeping services, concierge services, engineering services, front desk services, general manager services, meeting room services, restaurant services, room service, security services, wake up call services, telephone services, and/or other services. According to one embodiment of the invention, client terminal devices are configured to enable hotel guests to perform some actions that are currently performed by front desk attendants.

The invention has numerous advantages over and avoids many drawbacks of prior systems. These and other objects, features, and advantages of the invention will be apparent through the detailed description of the embodiments and the drawings attached hereto. It is also to be understood that both the foregoing general description and the following detailed description are exemplary and not restrictive of the scope of the invention. Numerous other objects, features, and advantages of the invention should now become apparent upon a reading of the following detailed description when taken in conjunction with the accompanying drawings, a brief description of which is included below.

### BRIEF DESCRIPTION OF THE DRAWINGS

The drawings appended hereto are intended to illustrate contemplated embodiments of the invention. The drawings are not intended to limit the invention solely to the embodiments illustrated and described.

FIG. 1A illustrates a system diagram according to one embodiment of the present invention.

FIG. 1B illustrates an exemplary embodiment of a client terminal device.

FIG. 1C illustrates an exemplary embodiment of hardware that may be associated with selected aspects of the system of the present invention.

FIG. 2 illustrates a screen-shot of a hotel guest welcome user interface according to one embodiment of the invention.

FIG. 3 illustrates a screen-shot of a housekeeping user interface according to one embodiment of the invention.

FIG. 4 illustrates a screen-shot of an engineering user interface according to one embodiment of the invention.

FIG. 5A illustrates a screen-shot of a restaurants user interface according to one embodiment of the invention.

FIG. 5B illustrates a screen-shot of a reservation screen, according to one embodiment of the invention that is associated with the restaurants user interface.

FIG. 6 illustrates a screen-shot of a wake-up call user interface according to one embodiment of the invention.

FIG. 7 illustrates a screen-shot of an outside call user interface according to one embodiment of the invention.

FIG. 8 illustrates a screen-shot of a long distance call user interface according to one embodiment of the invention.

FIG. 9 illustrates a screen-shot of a local call user interface according to one embodiment of the invention.

FIG. 10 illustrates a screen-shot of a dial a guest room user interface according to one embodiment of the invention.

FIG. 11 illustrates a screen-shot of a security user interface according to one embodiment of the invention.

FIG. 12 illustrates a screen-shot of an accounting user interface according to one embodiment of the invention.

FIG. 13 illustrates a screen-shot of a room service user interface according to one embodiment of the invention.

FIG. 14 illustrates a screen-shot of a banquet scheduling user interface according to one embodiment of the invention.

FIG. 15 illustrates a screen-shot of a concierge user interface according to one embodiment of the invention.

FIG. 16 illustrates a screen-shot of a front desk user interface according to one embodiment of the invention.

FIG. 17 illustrates a screen-shot of a meeting room services user interface according to one embodiment of the invention.

FIG. 18 illustrates a screen-shot of a general manager user interface according to one embodiment of the invention.

FIG. 19 illustrates a screen-shot of a front desk user interface according to one embodiment of the invention.

FIG. 20 illustrates a screen-shot of a guest search user interface according to one embodiment of the invention.

FIG. 21 illustrates a flow chart diagram for operating a hotel's main program according to one embodiment of the invention.

FIG. 22 illustrates a flow chart diagram for operating a guest program according to one embodiment of the invention.

FIG. 23 illustrates a flow chart diagram for operating a front desk program according to one embodiment of the invention.

FIG. 24 illustrates a flow chart diagram for implementing a housekeeping selection of the guest program according to one embodiment of the invention.

FIG. 25 illustrates a flow chart diagram for implementing a housekeeping selection of the front desk program according to one embodiment of the invention.

FIG. 26 illustrates a flow chart diagram for implementing an engineering selection of the guest program according to one embodiment of the invention.

FIG. 27 illustrates a flow chart diagram for implementing an engineering selection of the front desk program according to one embodiment of the invention.

FIG. 28 illustrates a flow chart diagram for implementing a restaurants selection of the guest program according to one embodiment of the invention.

FIG. 29 illustrates a flow chart diagram for implementing a restaurants selection of the front desk program according to one embodiment of the invention.

FIG. 30 illustrates a flow chart diagram for implementing a wake up call selection of the guest program according to one embodiment of the invention.

FIG. 31 illustrates a flow chart diagram for implementing a wake up call selection of the front desk program according to one embodiment of the invention.

FIG. 32 illustrates a flow chart diagram for implementing an outside call selection of the guest program according to one embodiment of the invention.

FIG. 33 illustrates a flow chart diagram for implementing an outside call selection of the front desk program according to one embodiment of the invention.

FIG. 34 illustrates a flow chart diagram for implementing a dial a guest room selection of the guest program according to one embodiment of the invention.

FIG. 35 illustrates a flow chart diagram for implementing a dial a guest selection of the front desk program according to one embodiment of the invention.

FIG. 36 illustrates a flow chart diagram for implementing a guest search selection of the front desk program according to one embodiment of the invention.

FIG. 37 illustrates a flow chart diagram for implementing a front desk selection of the guest program according to one embodiment of the invention.

FIG. 38 illustrates a flow chart diagram for implementing an accounting selection of the guest program according to one embodiment of the invention.

FIG. 39 illustrates a flow chart diagram for implementing an accounting selection of the front desk program according to one embodiment of the invention.

FIG. 40 illustrates a flow chart diagram for implementing a banquet scheduling selection of the guest program according to one embodiment of the invention.

FIG. 41 illustrates a flow chart diagram for implementing a banquet scheduling selection of the front desk program according to one embodiment of the invention.

FIG. 42 illustrates a flow chart diagram for implementing a concierge selection of the guest program according to one embodiment of the invention.

FIG. 43 illustrates a flow chart diagram for implementing a concierge selection of the front desk program according to one embodiment of the invention.

FIG. 44 illustrates a flow chart diagram for implementing a general manager selection of the guest program according to one embodiment of the invention.

FIG. 45 illustrates a flow chart diagram for implementing a general manager selection of the front desk program according to one embodiment of the invention.

FIG. 46 illustrates a flow chart diagram for implementing a meeting room services selection of the guest program according to one embodiment of the invention.

FIG. 47 illustrates a flow chart diagram for implementing a meeting room services selection of the front desk program according to one embodiment of the invention.

FIG. 48 illustrates a flow chart diagram for implementing a room service selection of the guest program according to one embodiment of the invention.

FIG. 49 illustrates a flow chart diagram for implementing a room service selection of the front desk program according to one embodiment of the invention.

FIG. 50 illustrates a flow chart diagram for implementing a security selection of the guest program according to one embodiment of the invention.

FIG. 51 illustrates a flow chart diagram for implementing a security selection of the front desk program according to one embodiment of the invention.

### DETAILED DESCRIPTION OF THE INVENTION

While specific embodiments of the invention are discussed herein and are illustrated in the drawings appended hereto, the invention encompasses a broader spectrum than the specific subject matter described and illustrated. As would be appreciated by those skilled in the art, the embodiments described herein provide but a few examples of the broad scope of the invention. There is no intention to limit the scope of the invention only to the embodiments described.

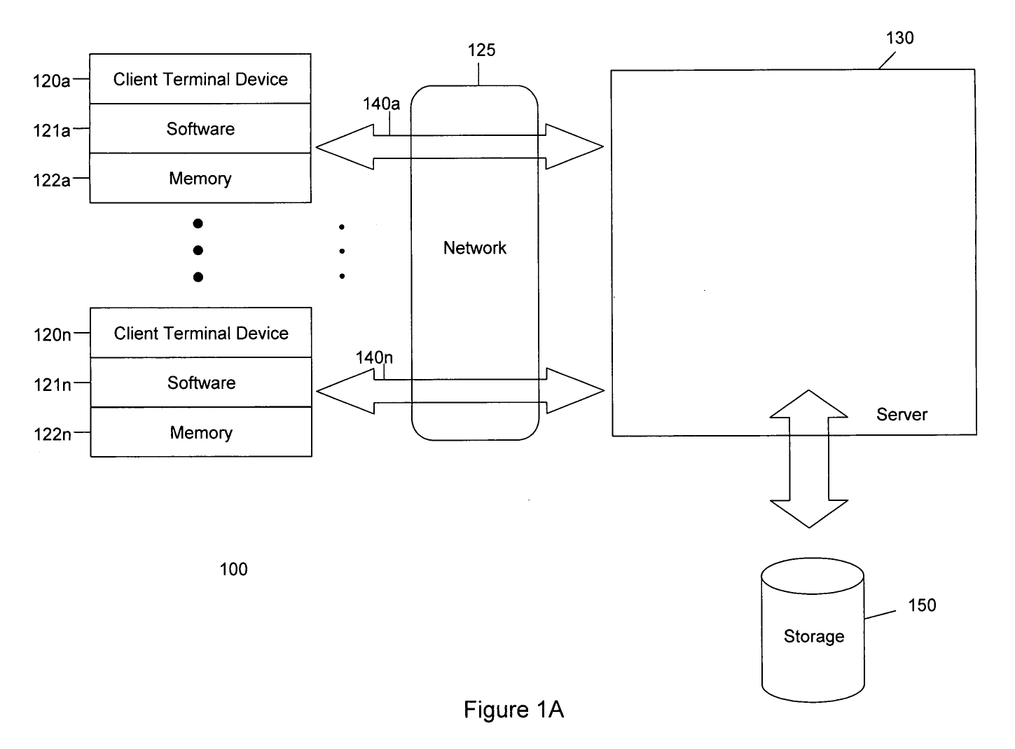

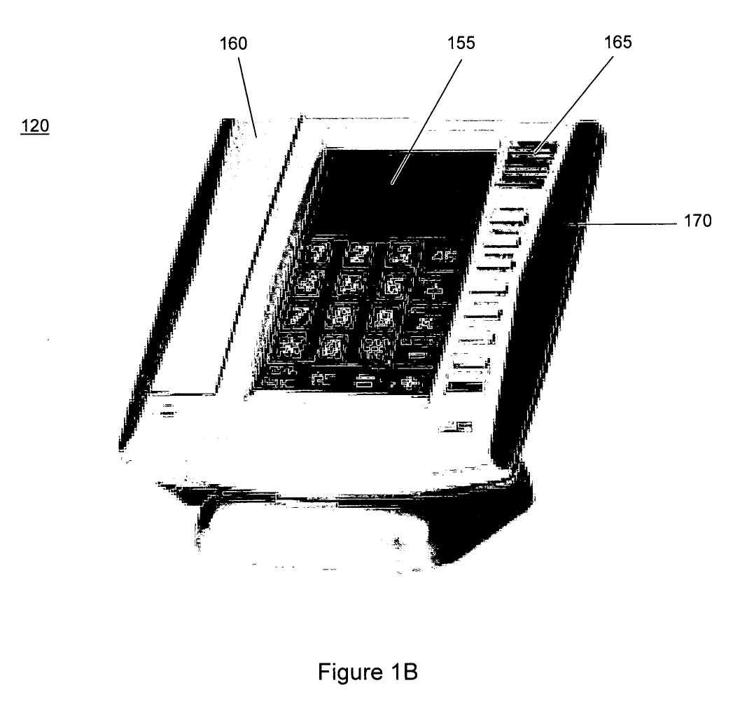

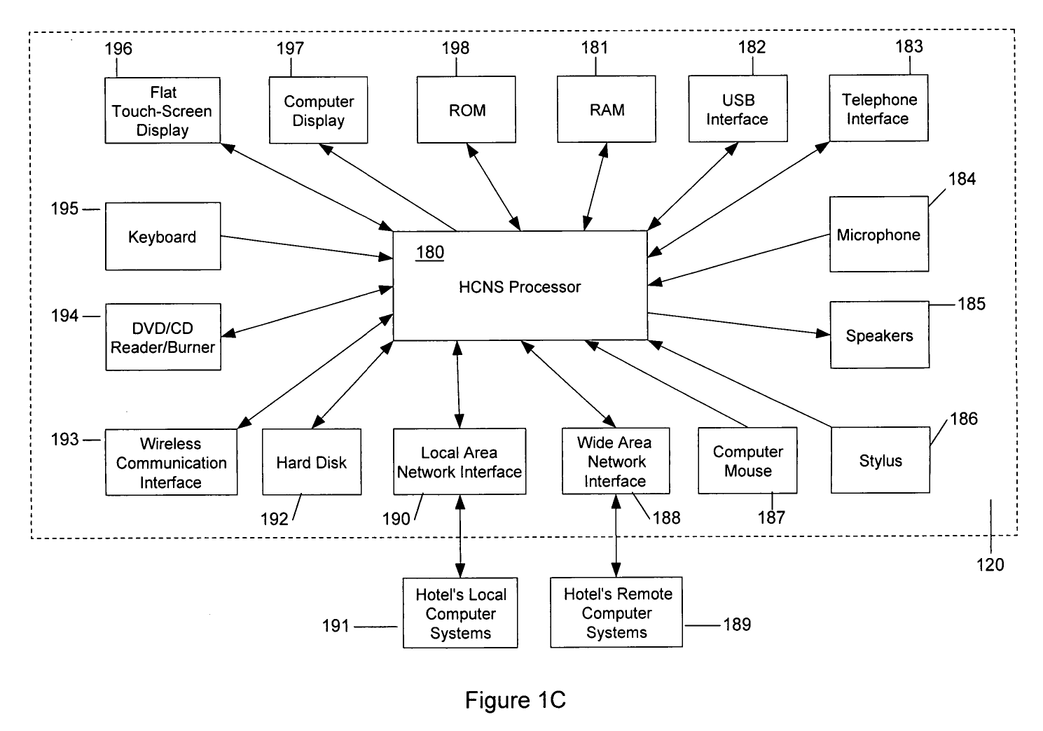

Widespread use of computer networks offers great potential for automating information retrieval and service requests, both as an enabling infrastructure and as a platform for supporting new applications. FIG. 1A illustrates an example of the system architecture 100 according to one embodiment of the invention. Client terminal devices 120a-120n (hereinafter identified collectively as 120) and one or more servers 130 may be connected via a wired network, a wireless network, a combination of the foregoing and/or other network(s) (for example a local area network) 125. FIG. 1B illustrates an exemplary embodiment of client terminal device 120 that includes a touch-sensitive display screen 155, a handset 160, a speaker 165 and input buttons 170, among other features.

FIG. 1C illustrates an exemplary embodiment of selected aspects of the system architecture 100. In particular, in the illustrated embodiment, client terminal device 120 includes processor 180, RAM 181, USB interface 182, telephone interface 183, microphone 184, speakers 185, stylus 186, computer mouse 187, wide area network interface 188, local area network interface 190, hard disk 192, wireless communication interface 193, DVD/CD reader/burner 194, keyboard 195, flat touch-screen display 196, computer display 197, among other components. Client terminal device 120 may communicate with a hotel's remote computer system 189, a hotel's local computer system 191, and/or other systems.

FIGS. 1A-1C are provided for illustrative purposes only and should not be considered limitations of the invention. Other configurations will be appreciated by those skilled in the art and are intended to be encompassed by the invention.

As alternatives to the embodiment illustrated in FIG. 1B, client terminal devices 120 may include any number of different types of client terminal devices, such as personal computers, laptops, smart terminals, personal digital assistants (PDAs), cell phones, Web TV systems, video game consoles, kiosks, devices that combine the functionality of one or more of the foregoing or other client terminal devices. Furthermore, a select function may be implemented by positioning an indicator over selected icons and manipulating an input receiving device such as a touch-sensitive display screen, a mouse, a keyboard, a voice recognition system or other input receiving devices. In the preferred embodiment, client terminal device 120 is a touch-sensitive display screen that is combined with an audio input device such as a telephone handset, as illustrated in FIG. 1B. Alternatively, client terminal device 120 may be a touch-sensitive display screen integrated with an audio input device such as a voice-activated telephone modem or other similar input device. In one further alternative embodiment, client terminal device 120 may include a video input device to permit audio-visual communication with other client terminal devices 120.

According to one embodiment of the invention, one or more client terminal devices 120 may be assigned to a single user. According to another embodiment of the invention, one or more client terminal devices 120 may be assigned directly or indirectly to a user. Regarding indirect assignment, a client terminal device 120 may be assigned to a hotel room and the user may be assigned to the same hotel room, thereby creating an association between client terminal device 120 and the user. According to another embodiment of the invention, the system may include an authentication feature that requests user credentials and validates users as registered hotel guests, hotel employees and/or other registered users.

According to one embodiment of the invention, client terminal devices 120 may be coupled to each other directly and/or indirectly and may communicate via communication media 140a-140n (hereinafter identified collectively as 140) such as, for example, any wireless and/or wired media. For example, a user may access client terminal device 120, which is located in an assigned hotel room, to request a service. The request may be broadcast to a wireless client terminal device 120 that is carried by a target recipient such as, a housekeeper, engineer or other target recipient. Communications between respective client terminal devices 120 may occur substantially in real-time if the client terminal devices 120 are connected to network 125.

Alternatively, the communications may be delayed for an amount of time if, for example, one or more client terminal devices 120 are not connected to network 125. According to one embodiment of the invention, any requests that are made while a client terminal device 120 is not connected to network 125 may be stored and propagated from/to the offline client terminal device 120 when both the source and target client terminal device 120 are re-connected to network 125. For example, if one of the source and target client terminal devices 120 is not connected to network 125, then requests remain in the corresponding client terminal device 120 for dissemination when the source and target client terminal devices 120 are re-connected to network 125.

According to one embodiment of the invention, communications may be performed between client terminal devices 120 and server 130 via network 125. According to another embodiment of the invention, network 125 may include the Internet. Client terminal devices 120 may communicate via communications media 140, such as, for example, any wired and/or wireless media. Communications between client terminal devices 120 and server 130 may occur substantially in real-time if the system is connected to the network 125. One of ordinary skill in the art will appreciate that communications may be conducted in various ways and among various devices.

According to one embodiment of the invention, any requests that are made from a source client terminal device to target client terminal devices may be stored for subsequent dissemination if corresponding client terminal devices 120 are not connected to network 125. The request may be stored in a storage device 150 associated with server 130 and/or a memory 122a-122n (hereinafter 122) associated with the source client terminal device 120. Upon reconnection to network 125, server 130 and/or client terminal devices 120 may cause information stored in storage device 150 and/or memory 122, respectively, to be forwarded to the corresponding target client terminal device 120.

According to another embodiment, the invention may include a feature that determines availability information about client terminal devices 120. The feature may detect whether client terminal devices 120 are operating online or offline and may detect a type of network connection for the client terminal devices 120, such as a wired connection, a wireless connection or other network connection.

Communications via network 125 may be implemented using current and future language conventions and/or current and future communications protocols that are generally accepted and used for generating and/or transmitting messages over the network 125. Language conventions may include Hypertext Markup Language (“HTML”), extensible Markup Language (“XML”) and other language conventions. Communications protocols may include, Hypertext Transfer Protocol (“HTTP”), TCP/IP, SSL/TLS, FTP, GOPHER, and/or other protocols.

According to one embodiment of the invention, client terminal devices 120 may include, or be modified to include, corresponding software 121a-121n (hereinafter identified collectively as 121) that may operate to provide hotel information and hotel services. Hotel information may include banquet scheduling information, concierge information, engineer information, front desk information, general manager information, housekeeping information, meeting room information, restaurant information, room service information, security information, wake up call information, telephone call information, hotel guest information, local events information, Internet access information and/or other information. Hotel services may include accounting services, housekeeping services, concierge services, engineering services, front desk services, general manager services, meeting room services, restaurant services, room service, security services, wake up call services, telephone services, and/or other services.

Client terminal device 120 may be of modular construction to facilitate adding, deleting, updating and/or amending modules therein and/or features within modules. Modules may include software 121, memory 122, or other modules. It should be readily understood that a greater or lesser number of modules might be used. One skilled in the art will readily appreciate that the invention may be implemented using individual modules, a single module that incorporates the features of two or more separately described modules, individual software programs, and/or a single software program.

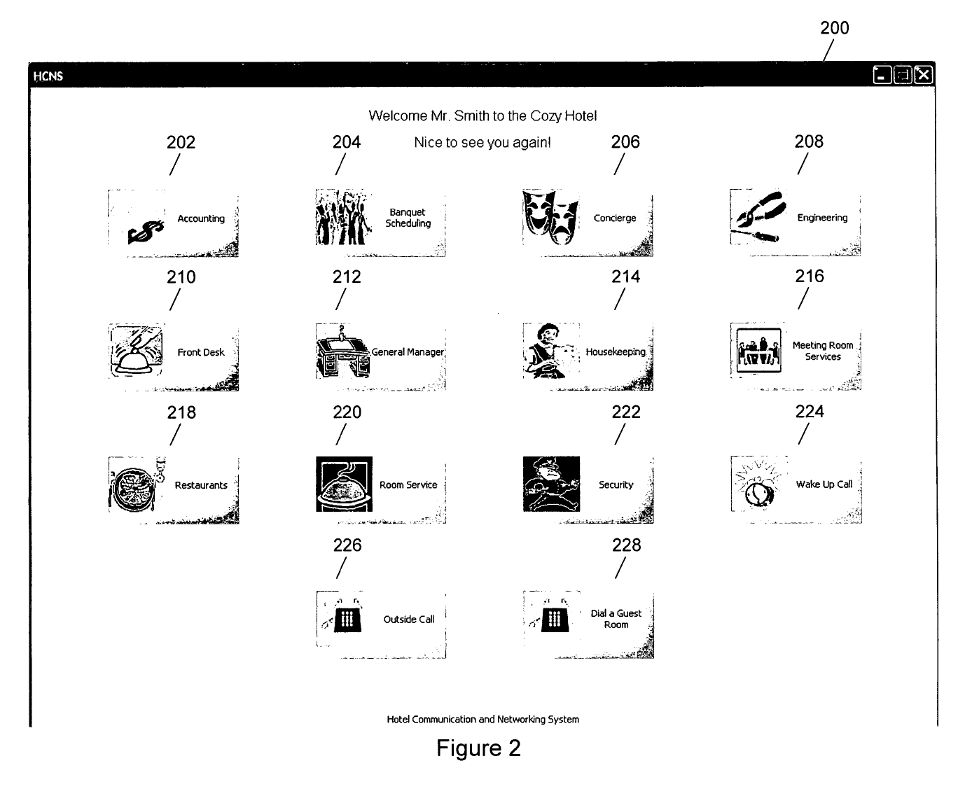

FIG. 2 illustrates an exemplary screen-shot of a welcome user interface (UI) 200 that may be associated with the corresponding client terminal device 120. Upon launching software 121, which resides on client terminal device 120 and/or server 130, UI 200 may be presented to the user. Various user interfaces are described below that provide primary mechanisms for interaction between user and software 121.

UI 200 provides a layout of components with which the user interacts with software 121. UI 200 may include a plurality of icons such as, for example, an accounting icon 202, a banquet scheduling icon 204, a concierge icon 206, an engineering icon 208, a front desk icon 210, a general manager icon 212, a housekeeping icon 214, a meeting room services icon 216, a restaurants icon 218, a room service icon 220, a security icon 222, a wake-up call icon 224, an outside call icon 226, a dial a guest room icon 228, and/or other icons. The icons may be associated with hotel information and/or hotel services. In some cases, some or all of the hotel information and/or hotel services associated with the icons may be stored in memory 122 on client terminal device 120.

According to one embodiment, the invention may automatically authenticate a user that is associated with a hotel room, but may require users that are accessing the client terminal device 120 in a public area, such as a hotel lobby or other public area, to be authenticated before displaying welcome UI 200. If users are not authenticated, then the users may be invited to submit requested information or take other action. If the user is authenticated, then server 130 may perform other processing. For example, server 130 may load data or other information (e.g., download) to client terminal device 120 that an authorized user may be permitted to access, but has not yet received from server 130 (e.g., data in storage device 150). Furthermore, client terminal device 120 may directly receive data or other information from another client terminal device 120 that the registered user may be permitted to access, but has not yet received from the other client terminal device 120.

With regard to user authentication, one of several different authentication schemes may be employed, and would be appreciated by those skilled in the art. For example, the user may be asked to input an alphanumeric code. Alternatively, the user may be asked to provide biometric information (i.e., a thumbprint through a fingerprint scanner) or other suitable identifying information.

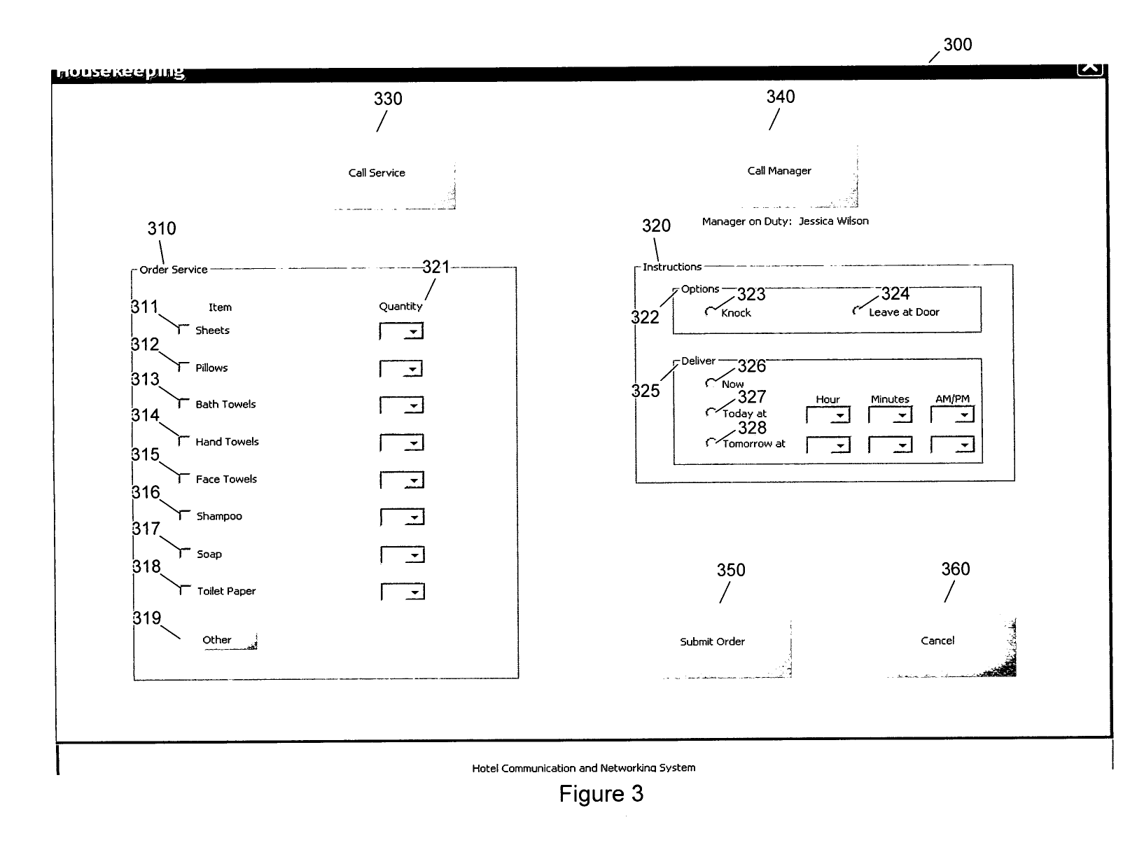

FIG. 3 illustrates an exemplary screen-shot of a housekeeping UI 300. Housekeeping UI 300 may include order service 310 and list various items 311-319 that are associated with order service 310. The various items may include sheets 311, pillows 312, bath towels 313, hand towels 314, face towels 315, shampoo 316, soap 317, toilet paper 318 or other items 319. Each item may be associated with a quantity 321 selection. Housekeeping UI 300 also may include instructions 320 having options 322 and deliver schedule 325, among other selections. Options 322 enable a user to select how the order is to be delivered to the user such as, with an alert 323 (e.g., a knock, etc.) or no alert 324 (e.g., leave at door, etc.). Deliver schedule 325 may include selection for immediate delivery 326, delivery today 327 at a specified time, or delivery tomorrow 328 at a specified time. After selecting the desired features, an order may be submitted using submit order icon 350. Alternatively, an order may be cancelled by selecting cancel icon 360.

Housekeeping UI 300 also may include a call service icon 330 that enables users to contact the housekeeping service. Messages may be transferred to a portable client terminal device that is assigned to hotel housekeepers. In one contemplated embodiment, the call service icon 300 may initiate a telephone call to a service agent on duty. Housekeeping UI 300 further may include a call manager icon 340 that displays a name of a manager on duty and enables the user to call the manager. According to one embodiment of the invention, a telephone call may be placed through client terminal device 120 or through an external device such as, a stand alone telephone or other communication device. Other selections may be provided.

With respect to other items 319, activation of the icon may bring up a visual alphanumeric keyboard on the display of client terminal device 120. In the case where a touch screen is employed for input, the user may type in the housekeeping request. If a keyboard is associated with the client terminal device 120, the user may type in the housekeeping request thereby.

Concerning the quantity selection icon 321, if the user desires more than one of a particular item, the user may activate the quantity selection icon 321, thereby causing the display of a drop-down menu that provides the user with a number of choice options. Alternatively, activation of the quantity selection icon 321 may bring up a numeric keyboard permitting the user to type in the desired quantity via the touch-sensitive screen. Alternatively, a keyboard may be used, if available. Other quantity selection input methods will be appreciated by those skilled in the art and are intended to be encompassed by the invention.

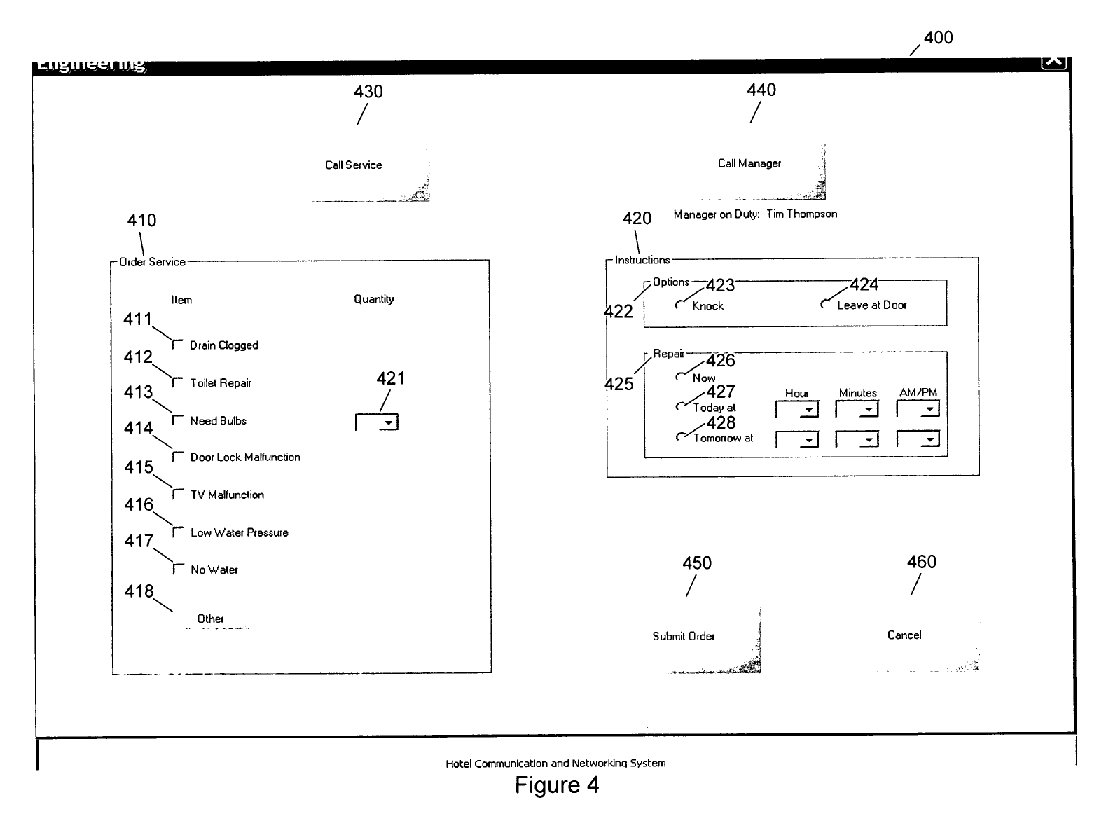

FIG. 4 illustrates an exemplary screen-shot of an engineering UI 400. Engineering UI 400 may include order service 410 and list various items 411-418 that are associated with order service 410. The various items may include drain clogged 411, toilet repair 412, need bulbs 413, door lock malfunction 414, TV malfunction 415, low water pressure 416, no water 417, or other items 418. One or more items, such as need bulbs 413, may be associated with a quantity 421 selection. Engineering UI 400 also may include instructions 420 having options 422 and repair schedule 425, among other selections. Options 422 enable a user to select how the order is to be provided to the user such as, with an alert 423 (e.g., a knock, etc.) or no alert 424 (e.g., leave at door, etc.). The no alert 424 option is associated with items, such as need bulbs 413, where the engineering service may be performed by the user. Other items that require a repair engineer to be present, such as drain clogged, may not be eligible for the no alert 424 option. Repair schedule 425 may include selection for immediate repair 426, repair today 427 at a specified time, or repair tomorrow 428 at a specified time. After selecting the desired features, an order may be submitted using submit order icon 450. Alternatively, an order may be cancelled at any time by selecting cancel icon 460.

Engineering UI 400 also may include a call service icon 430 that enables users to contact the engineering service. Messages may be transferred to a portable client terminal device that is assigned to hotel engineers. Alternatively, activation of call service icon 430 may initiate a telephone connection to the engineer on duty. Engineering UI 400 further may include a call manager icon 440 that displays a name of a manager on duty and enables the user to call the manager. According to one embodiment of the invention, a telephone call may be placed through client terminal device 120 or through an external device such as, a stand alone telephone or other communication device. Other selections may be provided.

As with the other items icon in FIG. 3, activation of the other items icon 418 may direct the user to a screen with an alphanumeric keyboard so that the user may type in the engineering request. As discussed in connection with FIG. 3, the client terminal 120 may be provided alternatively with a keyboard for input. In addition, the quantity selection icon 421 may operate similarly to the quantity selection icon 312, also described in connection with FIG. 3.

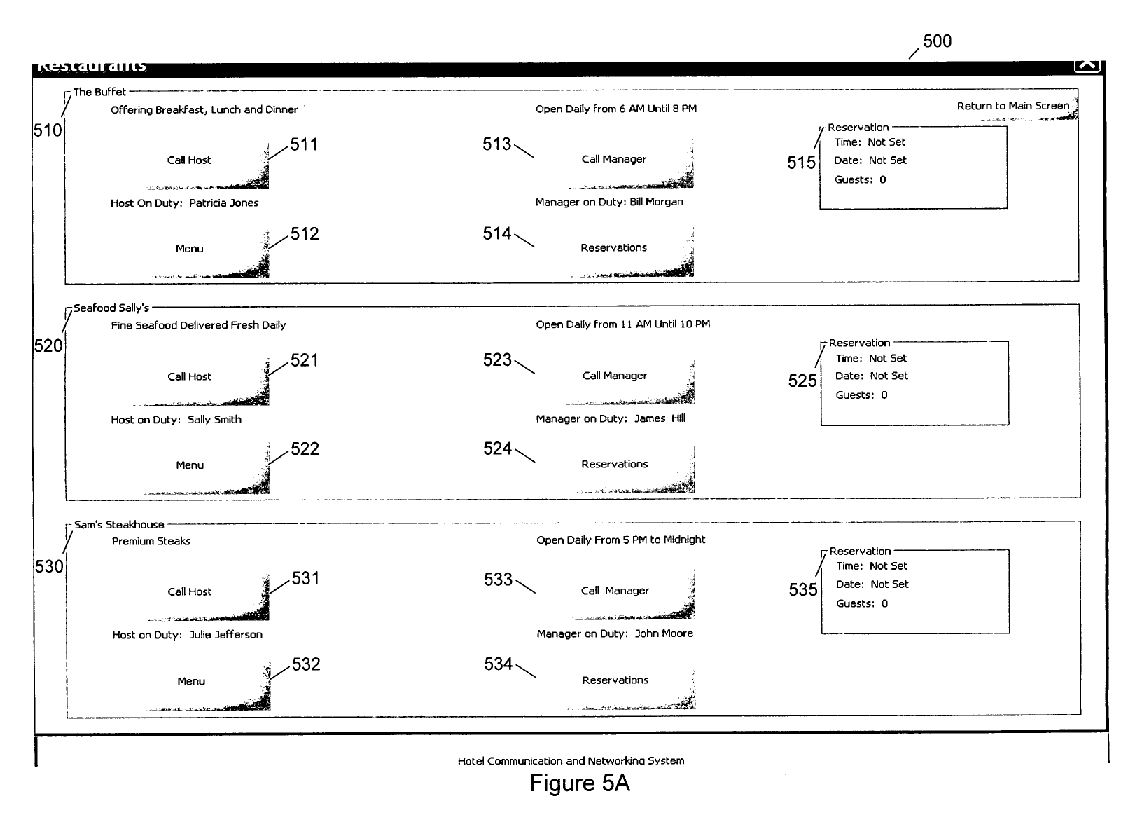

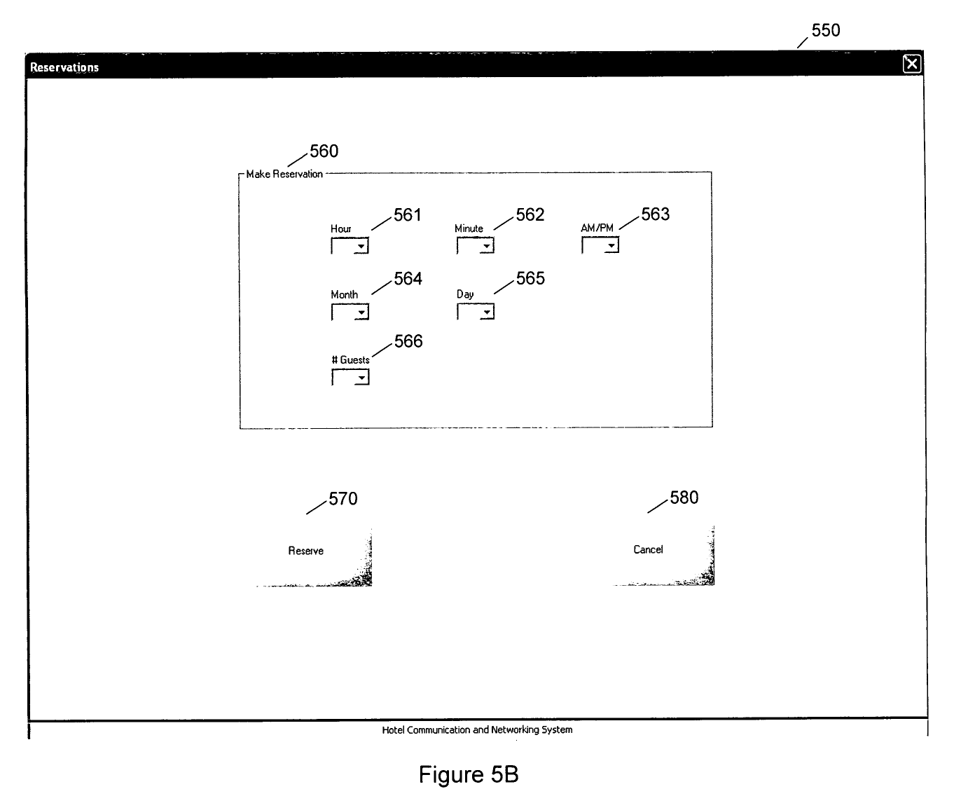

FIG. 5A illustrates an exemplary screen-shot of a restaurants UI 500. Restaurants UI 500 may include a restaurant name such as, The Buffet 510, Seafood Sally's 520, or Sam's Steakhouse 530, and lists various items (511-514, 521-524, 531-534) that are associated with a corresponding restaurant name. The various items may include call host (511, 521, 531), menu (512, 522, 532), call manager (513, 523, 533), reservations (514, 524, 534), or other items. Other information including a type of food, a host on duty, operating hours, manager on duty, and/or other information may be provided. Restaurants UI 500 also may include a reservation area (515, 525, 535) that includes reservation information such as, time, date, guests and/or other reservation information. Other events, attractions, or other entertainment may be provided. According to one embodiment of the invention, advertisements may be placed on the user interface to promote restaurants, events, attractions, or other entertainment. Additionally, any costs associated with the restaurants, events, attractions or other entertainment may be billed to the hotel room that is associated with the client terminal device.

FIG. 5B illustrates an exemplary screen-shot of a reservation UI 550. In order to access reservation UI 550, users may select reservation icons 514, 524, 534. Reservation UI 550 may include a make reservation area 560 having time entry elements for selection of hour 561, minute 562 and AM/PM 563, date entry elements for selection of a month 564 and day 565, and guest number selection 566. After selecting the desired features, a reservation may be submitted using reserve icon 570. Alternatively, the reservation may be cancelled by selecting cancel icon 580.

If a reservation is made using reserve icon 570, reservation area 515, 525, 535 associated with the restaurant selected will be updated to reflect the pertinent data associated with the reservation. If cancel icon 580 is later selected, reservation area 515, 525, 535 will be updated to remove the data associated with the canceled reservation.

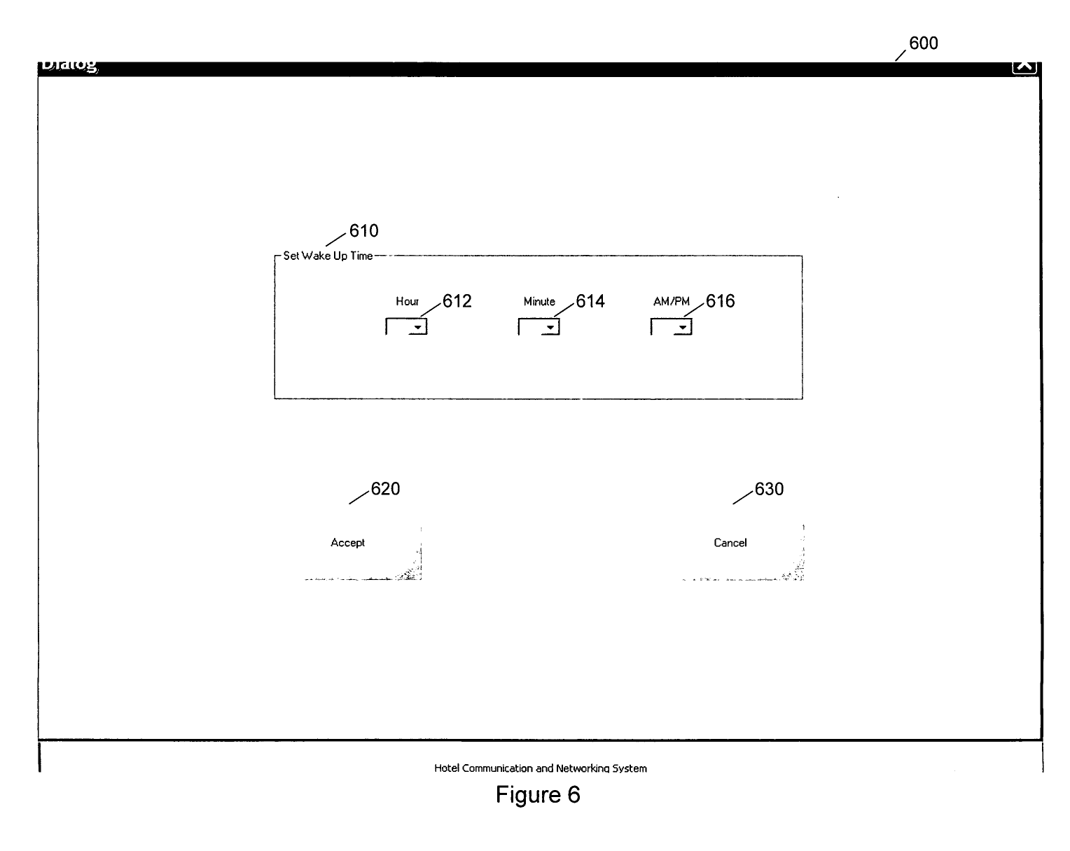

FIG. 6 illustrates an exemplary screen-shot of a wake-up call UI 600. Wake-up call UI 600 may include a set wake-up time area 610 and time entry elements including hour 612, minute 614 and AM/PM 616. After selecting the desired features, an order may be submitted using accept icon 620. According to one embodiment of the invention, the client terminal device 120 may control the wake-up call locally. Alternatively, the order may be cancelled at any time by selecting cancel icon 630.

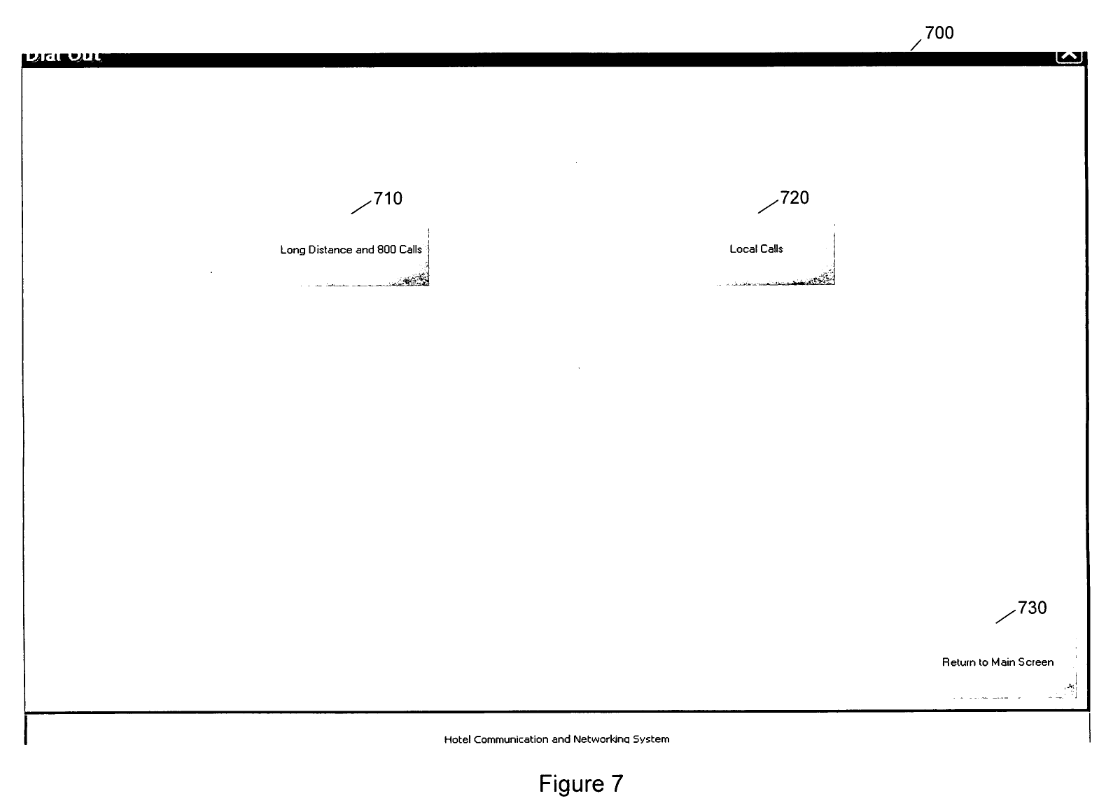

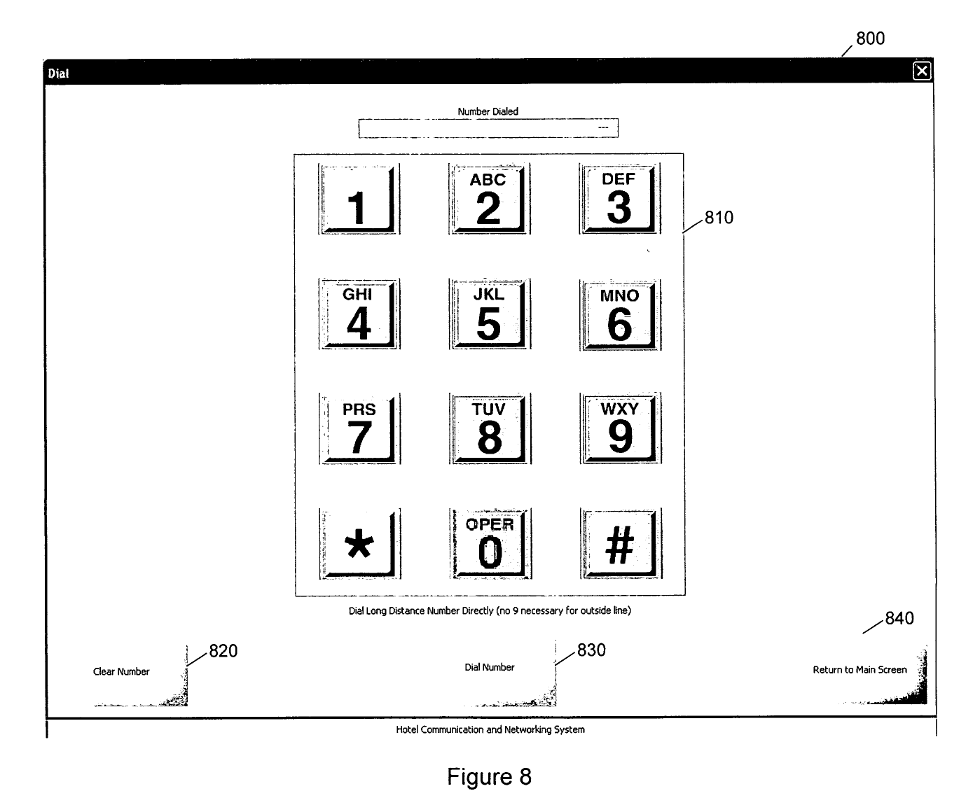

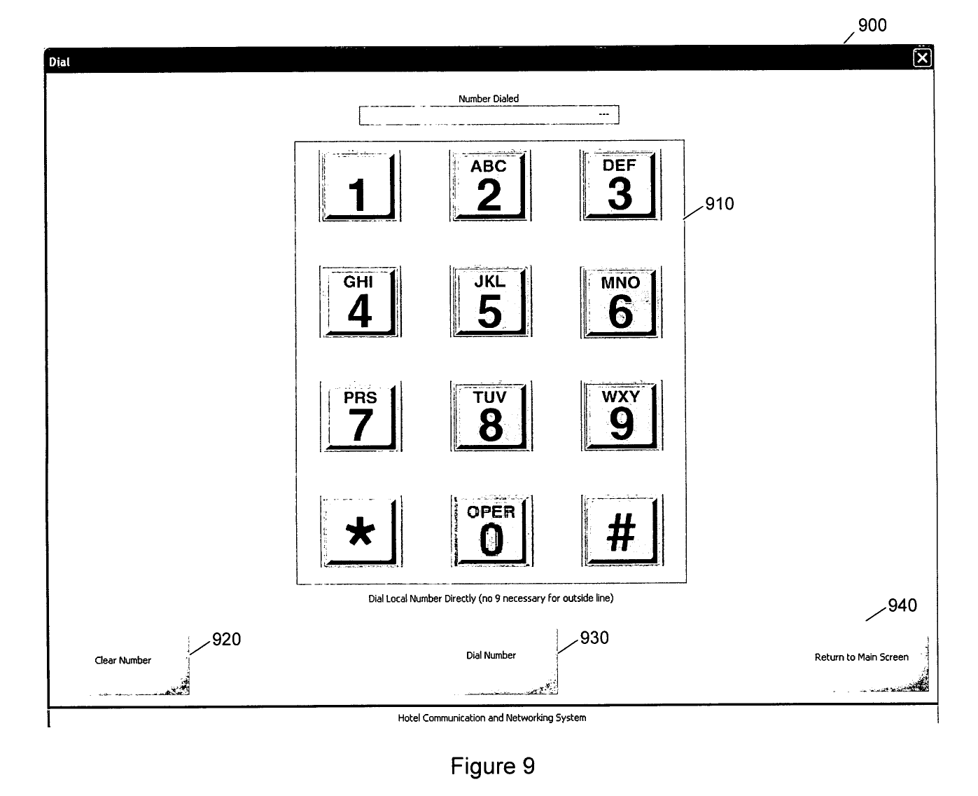

FIG. 7 illustrates an exemplary screen-shot of an outside call UI 700. Outside call UI 700 may include a long distance and 800 calls icon 710, a local calls icon 720, a return to main screen icon 730 or other icons. Upon selection of long distance and 800 calls icon 710, a long distance call UI 800 having a telephone keypad 810 may be displayed as illustrated in FIG. 8. Other selections may be provided. Upon selection of local calls icon 720, a local call UI 900 having a telephone keypad 910 may be displayed as illustrated in FIG. 9. FIGS. 8 and 9 may include clear number icon (820, 920), dial number icon (830, 930), and return to main screen icon (840, 940), among other icons. According to one embodiment of the invention, a telephone call may be placed through client terminal device 120 or through an external device such as, a stand alone telephone or other communication device. To ensure privacy, the client terminal device 120 supports headsets, telephone handsets, and/or other privacy devices.

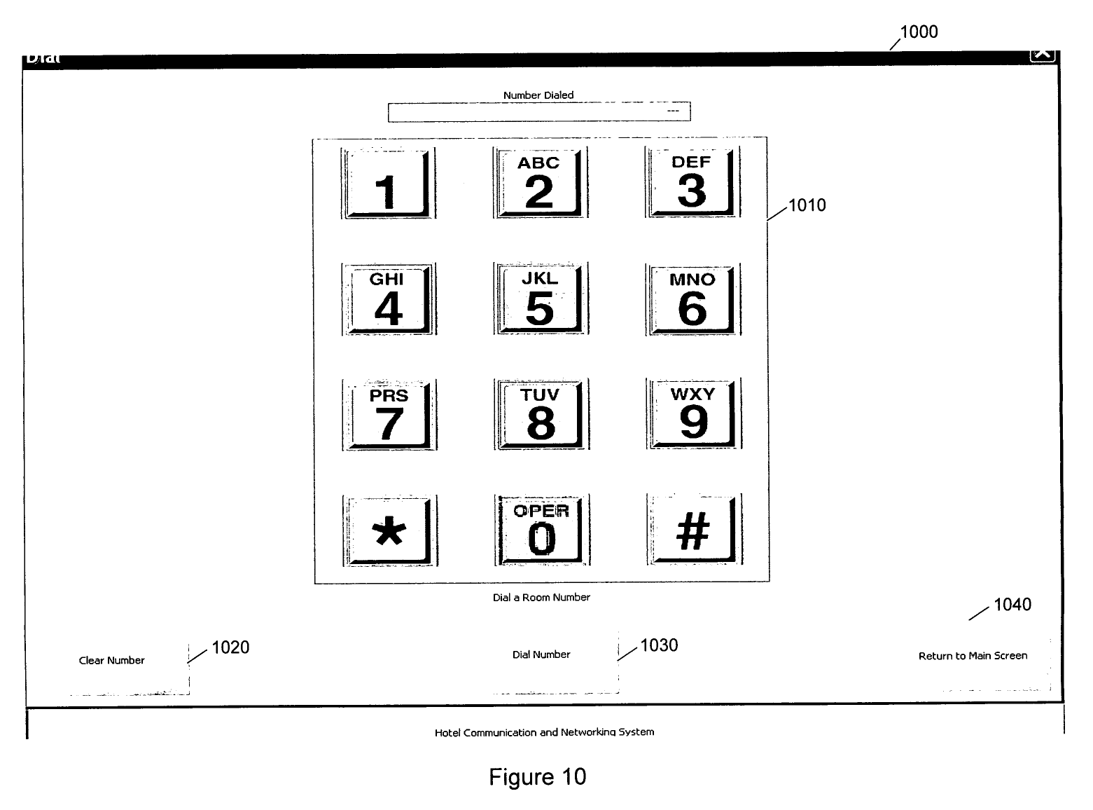

FIG. 10 illustrates an exemplary screen-shot of a dial a guest room UI 1000. Dial a guest room UI 1000 may include a telephone keypad 1010, clear number icon 1020, dial number icon 1030, and return to main screen icon 1040, among other icons. According to one embodiment of the invention, a telephone call may be placed through client terminal device 120 or through an external device such as, a stand alone telephone or other communication device. Other selections may be provided.

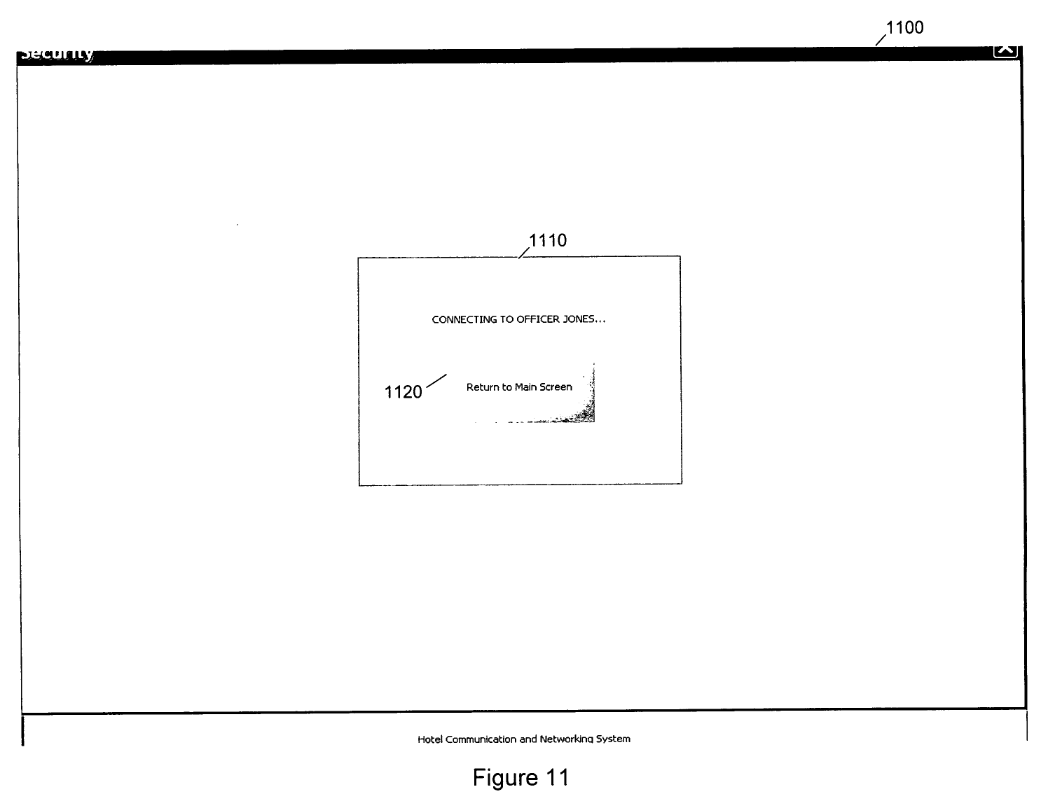

FIG. 11 illustrates an exemplary screen-shot of a security UI 1100 that includes an area 1110 that provides an officer name and a return to main screen icon 1120. According to one embodiment of the invention, a communication including a telephone call, page, instant message or other communication may be placed through client terminal device 120 or through an external device such as, a stand alone telephone or other communication device. Message may be transferred to a portable client terminal device that is assigned to hotel officers or other security officers. Other selections may be provided.

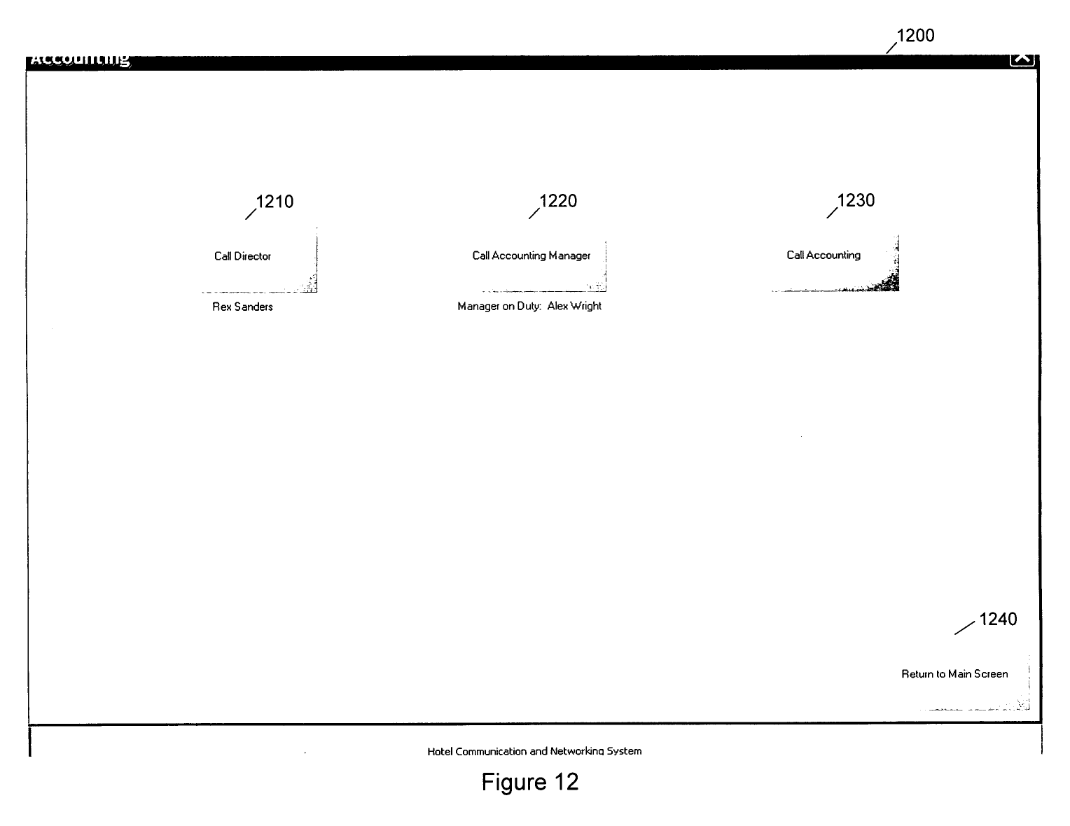

FIG. 12 illustrates an exemplary screen-shot of an accounting UI 1200 that includes a call director icon 1210, a call accounting manager icon 1220, a call accounting icon 1230, and a return to main screen icon 1240, among other icons. According to one embodiment of the invention, a telephone call may be placed through client terminal device 120 or through an external device such as, a stand alone telephone or other communication device. Other selections may be provided.

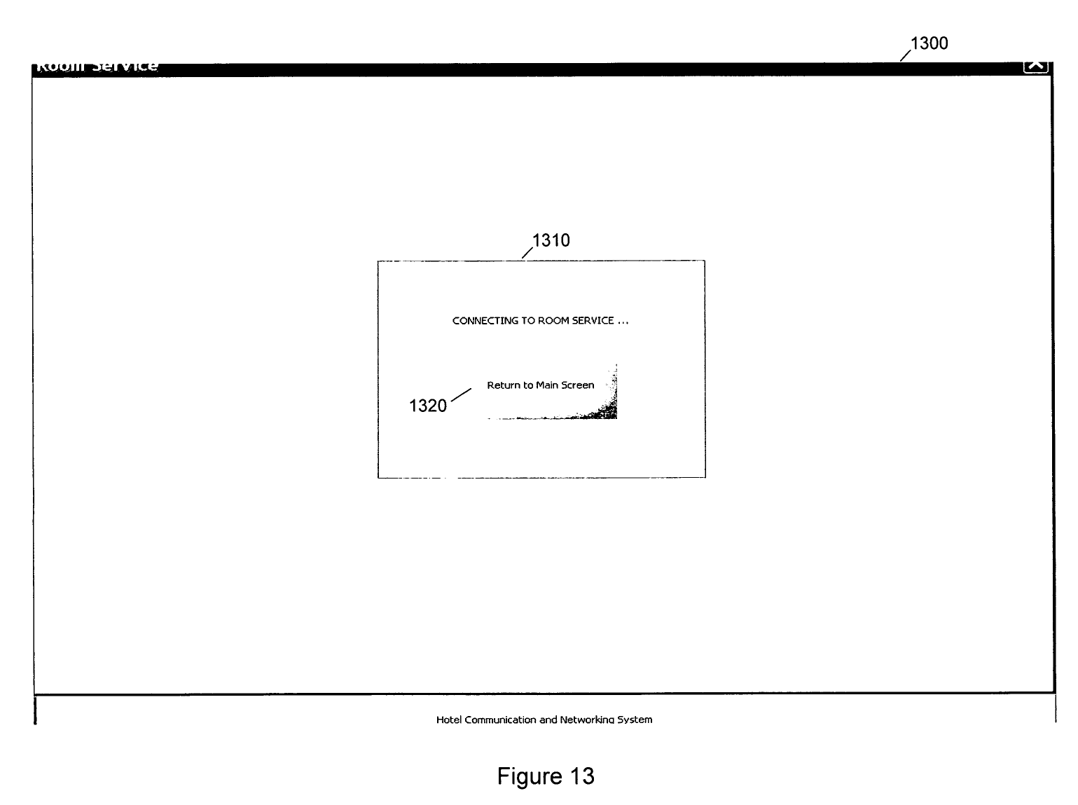

FIG. 13 illustrates an exemplary screen-shot of a room service UI 1300 that includes an area 1310 that provides a connecting to room service prompt and an return to main screen icon 1320. According to one embodiment of the invention, a telephone call may be placed through client terminal device 120 or through an external device such as, a stand alone telephone or other communication device. Other selections may be provided.

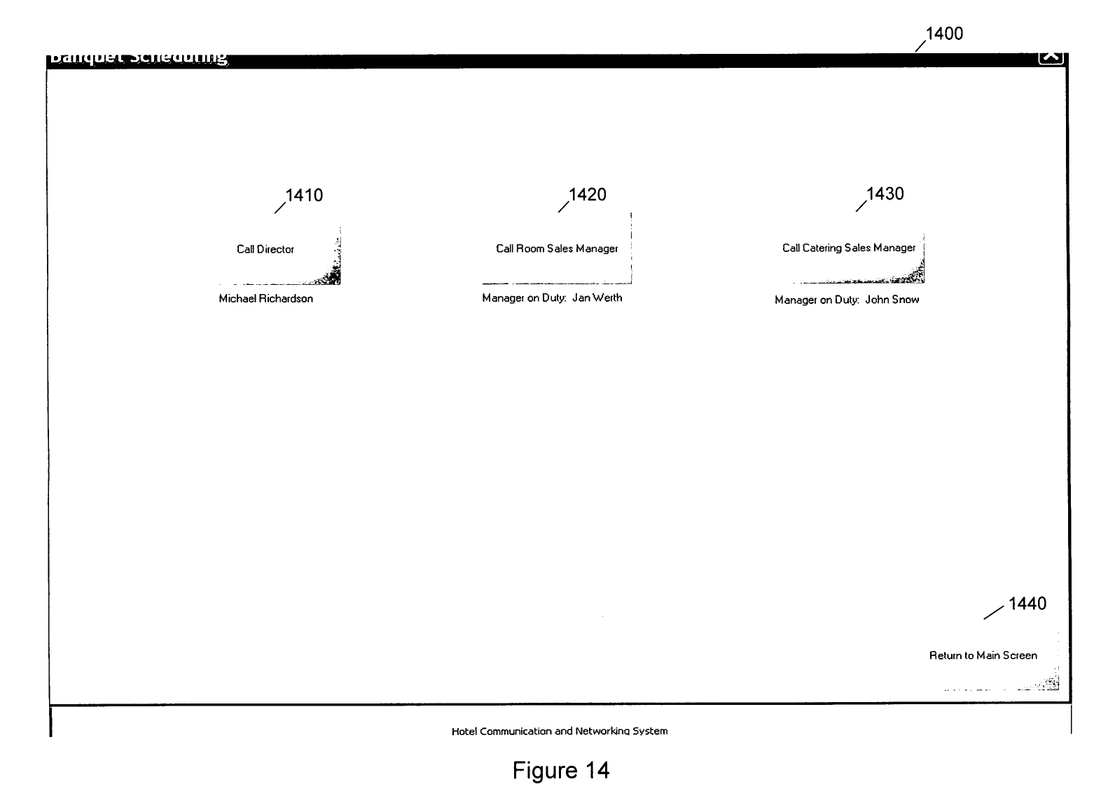

FIG. 14 illustrates an exemplary screen-shot of a banquet scheduling UI 1400 that includes a call director icon 1410, a call room sales manager icon 1420, a call catering sales manager icon 1430, and a return to main screen icon 1440, among other icons. According to one embodiment of the invention, a telephone call may be placed through client terminal device 120 or through an external device such as, a stand alone telephone or other communication device. Other selections may be provided.

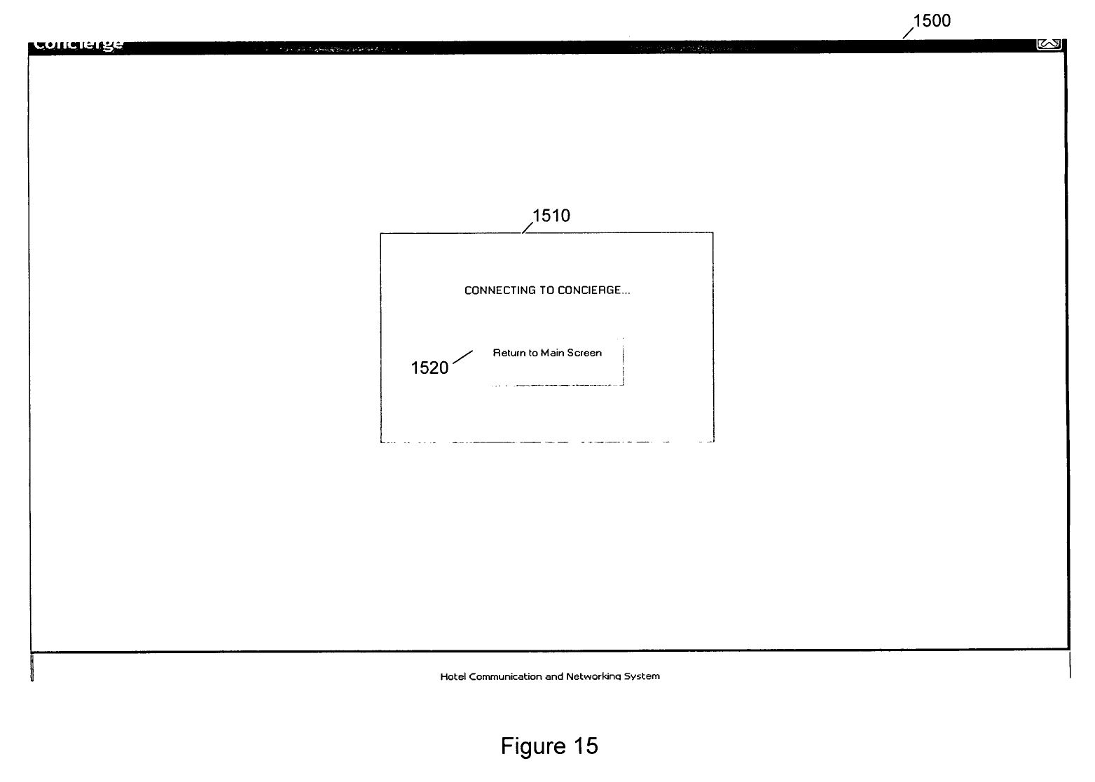

FIG. 15 illustrates an exemplary screen-shot of a concierge UI 1500 that includes an area 1510 that provides a connecting to concierge prompt and a return to main screen icon 1520. According to one embodiment of the invention, a telephone call may be placed through client terminal device 120 or through an external device such as, a stand alone telephone or other communication device. Other selections may be provided.

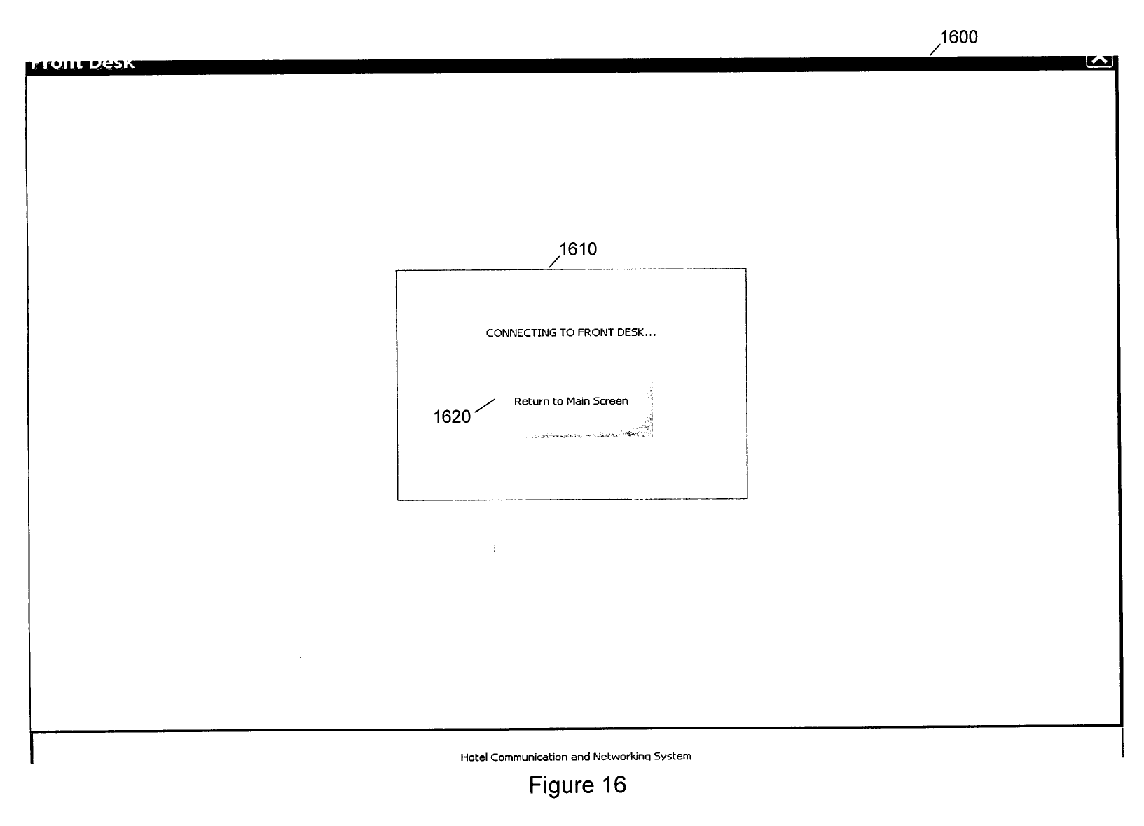

FIG. 16 illustrates an exemplary screen-shot of a front desk UI 1600 that includes an area 1610 that provides a connecting to front desk prompt and a return to main screen icon 1620. According to one embodiment of the invention, a telephone call may be placed through client terminal device 120 or through an external device such as, a stand alone telephone or other communication device. Other selections may be provided.

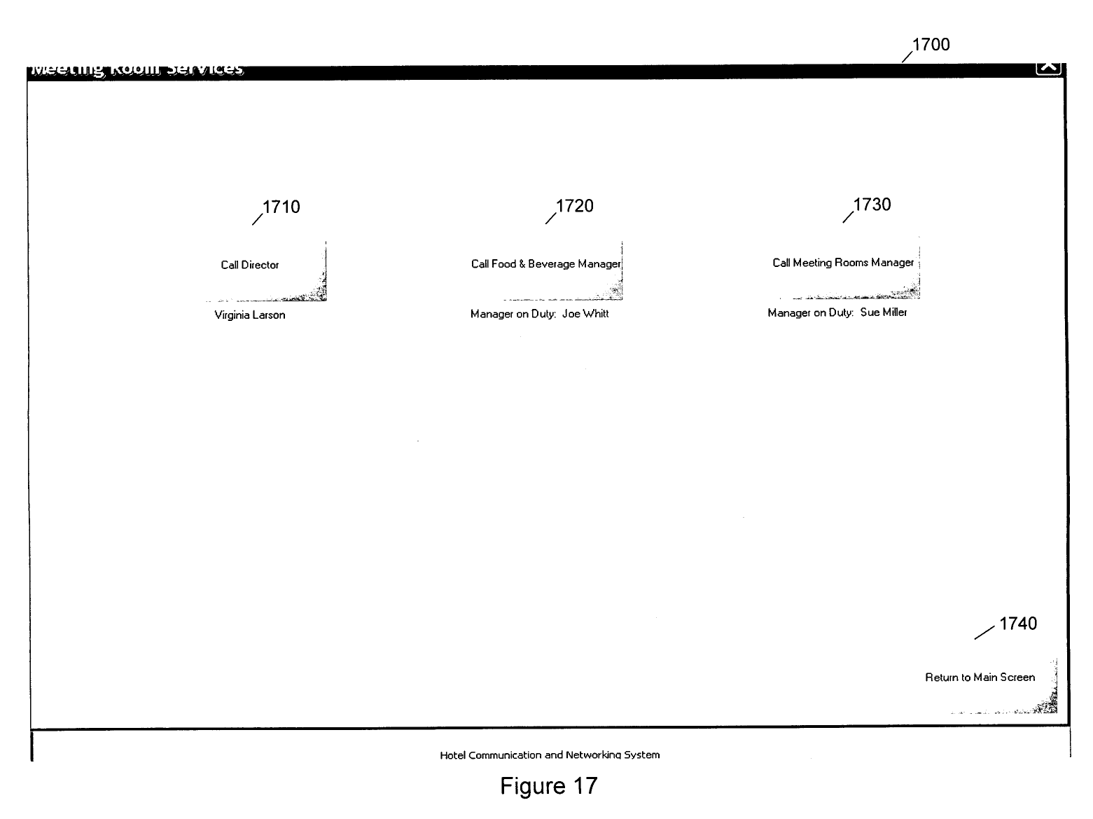

FIG. 17 illustrates an exemplary screen-shot of a meeting room services UI 1700 that includes a call director icon 1710, a call food and beverage manager icon 1720, a call meeting room manager icon 1730, and a return to main screen icon 1740, among other icons. According to one embodiment of the invention, a telephone call may be placed through client terminal device 120 or through an external device such as, a stand alone telephone or other communication device. Other selections may be provided.

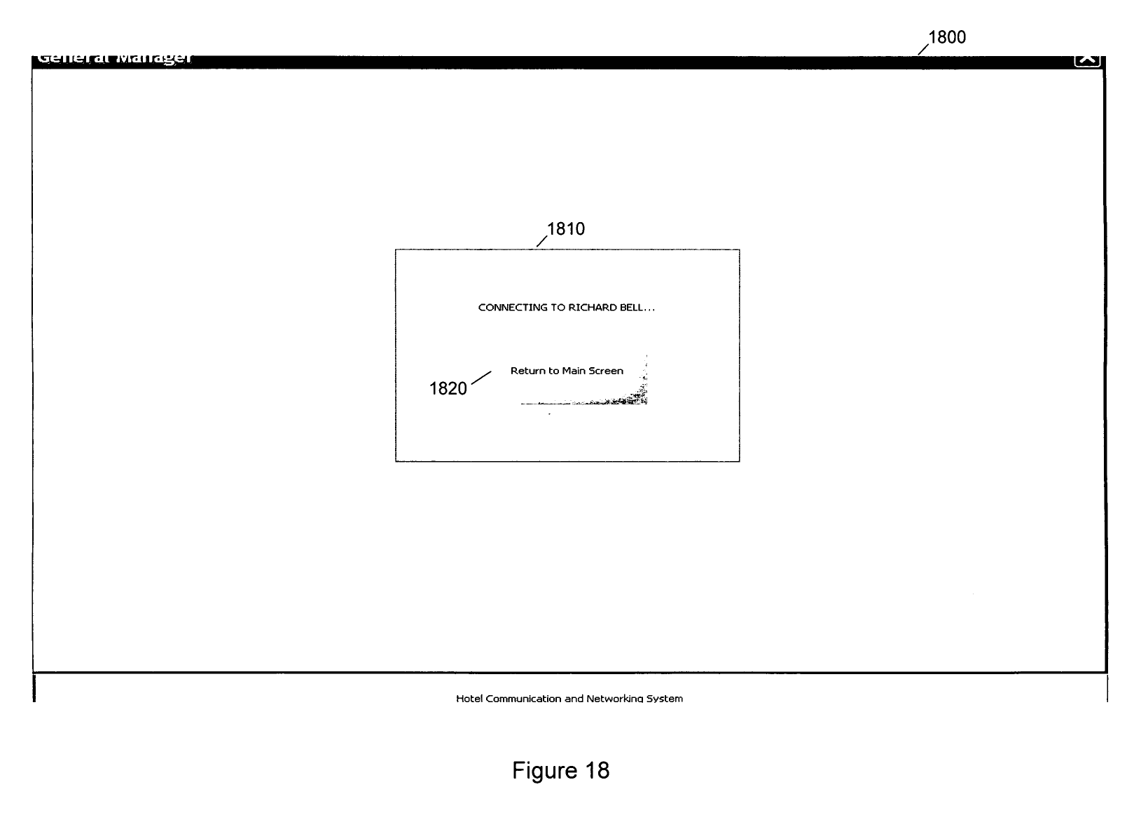

FIG. 18 illustrates an exemplary screen-shot of a general manager UI 1800 that includes an area 1810 that provides a connecting to the general manager prompt and a return to main screen icon 1820. According to one embodiment of the invention, a telephone call may be placed through client terminal device 120 or through an external device such as, a stand alone telephone or other communication device. Other selections may be provided.

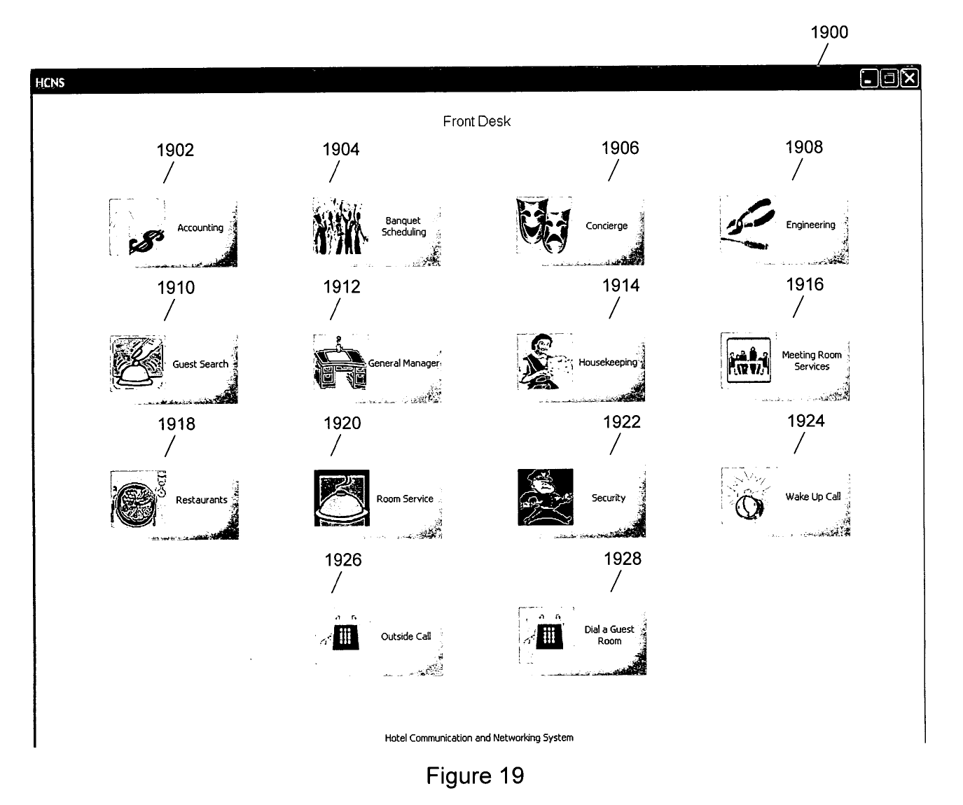

FIG. 19 illustrates an exemplary screen-shot of a front desk interface (UI) 1900 that may be associated with client terminal device 120 that is located at the front desk. Upon launching software 121, which resides on client terminal device 120 and/or server 130, UI 1900 may be presented to the user. Various user interfaces are described below that provide primary mechanisms for interaction between a front desk attendant and software 121.

With respect to UI 1900, it is noted that many of the same interfaces provided to a hotel guest are made available to the front desk attendant. Additional features are provided to the front desk attendant that, for security, privacy reasons and/or other reasons, are not available to the hotel guest.

UI 1900 provides a layout of components with which the front desk attendant interacts with software 121. UI 1900 may include a plurality of icons such as, for example, an accounting icon 1902, a banquet scheduling icon 1904, a concierge icon 1906, an engineering icon 1908, a guest search icon 1910, a general manager icon 1912, a housekeeping icon 1914, a meeting room services icon 1916, a restaurants icon 1918, a room service icon 1920, a security icon 1922, a wake-up call icon 1924, an outside call icon 1926, a dial a guest room icon 1928, and/or other icons. The icons may be associated with hotel information and/or hotel services. In some cases, some or all of the hotel information and/or hotel services associated with the icons may be stored in memory 122 on client terminal device 120.

According to one embodiment, the invention may automatically authenticate a front desk attendant. If front desk attendants are not authenticated, then the front desk attendants may be invited to submit requested information or take other action. If the front desk attendant is authenticated, then the server 130 may perform other processing. For example, server 130 may load data or other information (e.g., download) to the client terminal device 120 that an authorized front desk attendant may be permitted to access, but has not yet received from server 130 (e.g., data in storage device 150). Furthermore, client terminal device 120 may directly receive data or other information from another client terminal device 120 that the registered front desk attendant may be permitted to access, but has not yet received from the other client terminal device 120. Icons in the front desk UI 1900 that are similar to the welcome UI 200 described above may include the same features and therefore a description of these similar features is not repeated.

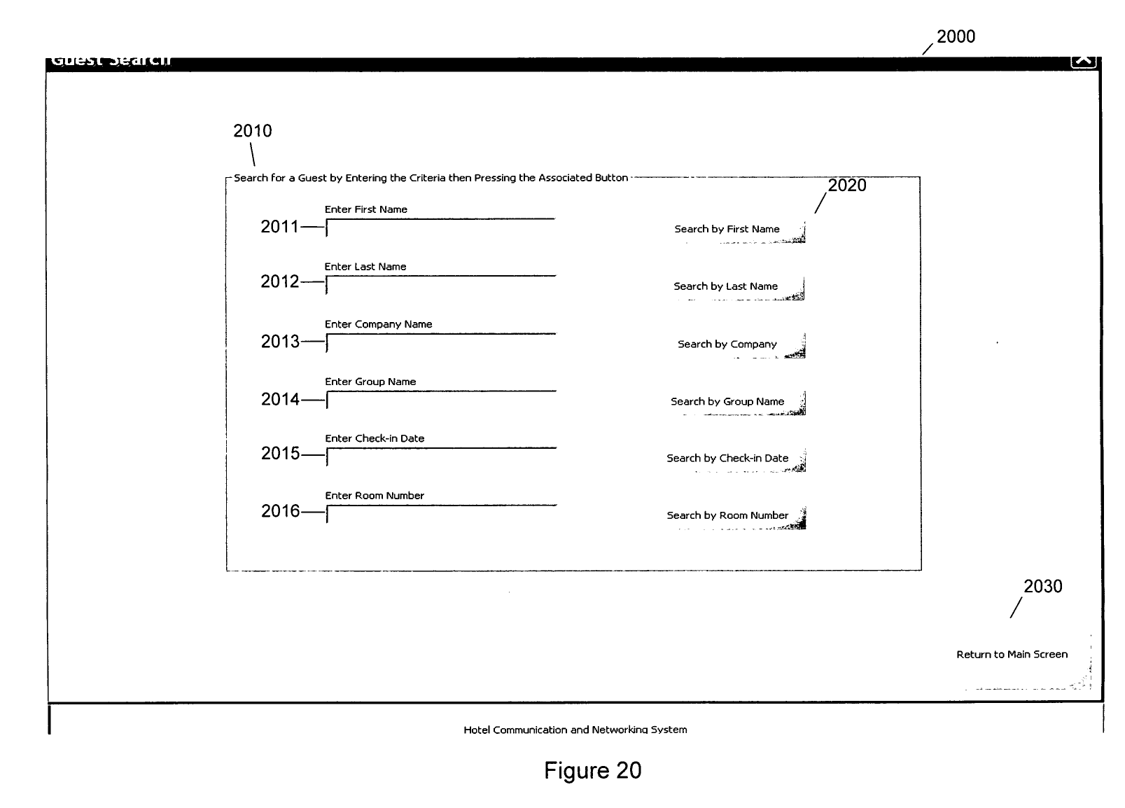

FIG. 20 illustrates an exemplary screen-shot of a guest search UI 2000. Guest search UI 2000 may include a search for guest area 2010 and various items 2011-2016 that are associated with search for guest area 2010. The various items may include first name entry 2011, last name entry 2012, company name entry 2013, group name entry 2014, check-in date entry 2015, room number entry 2016 or other items. Each item may be associated with a corresponding search button 2020. UI 2000 may also include a return to main screen icon 2020, among other icons.

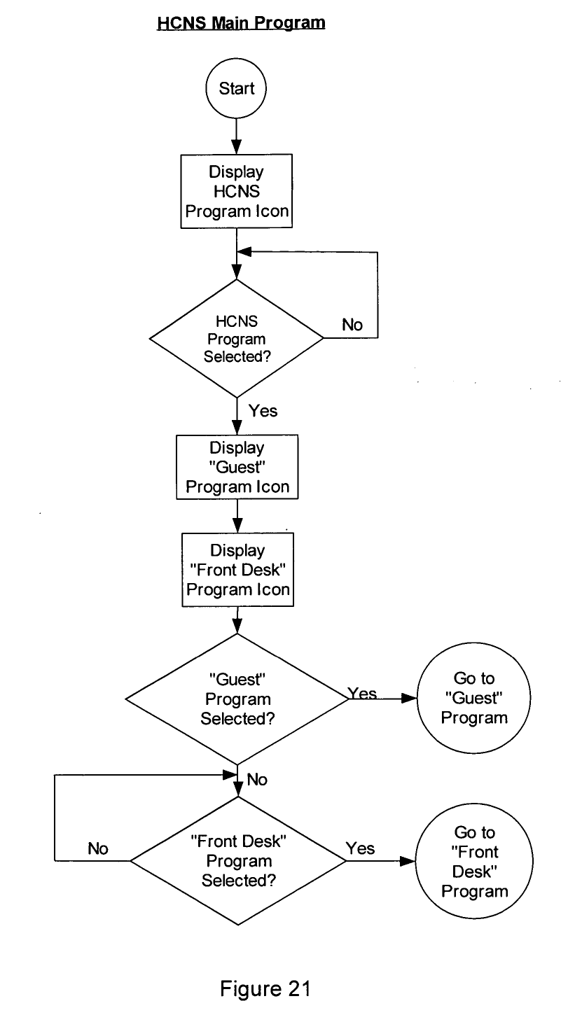

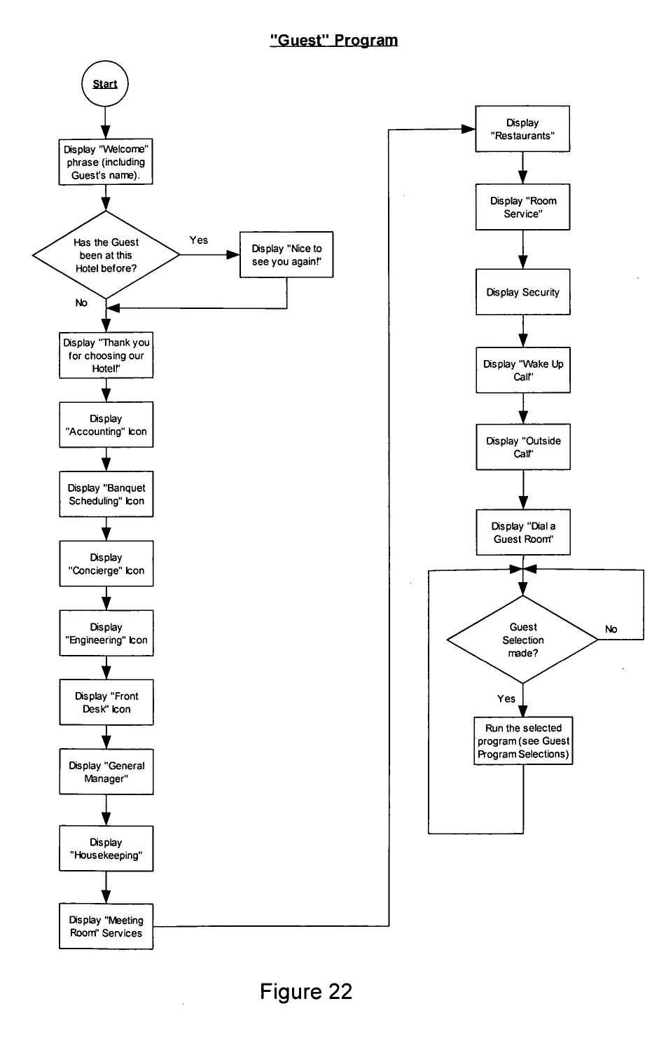

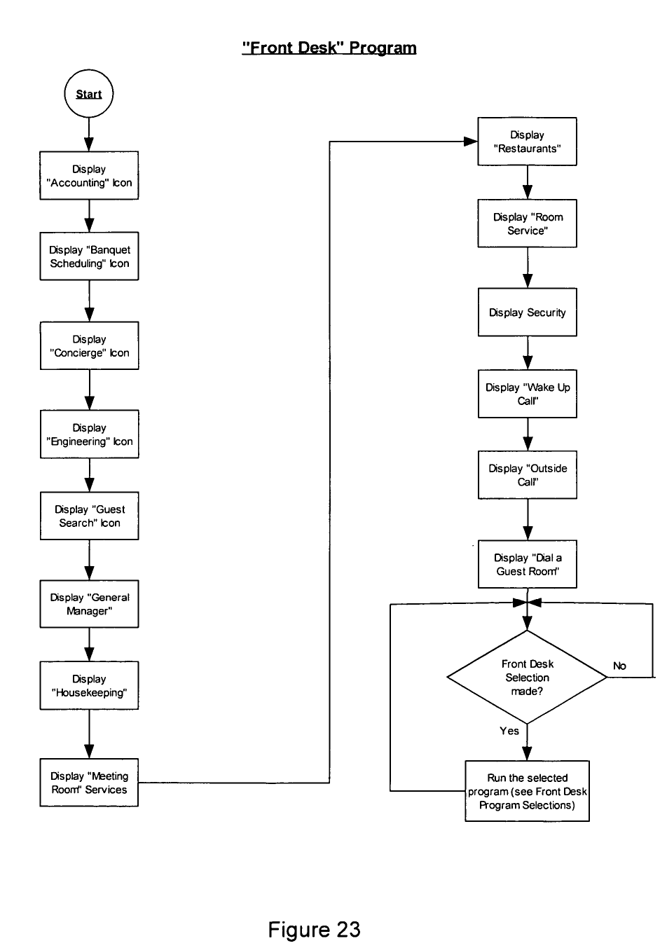

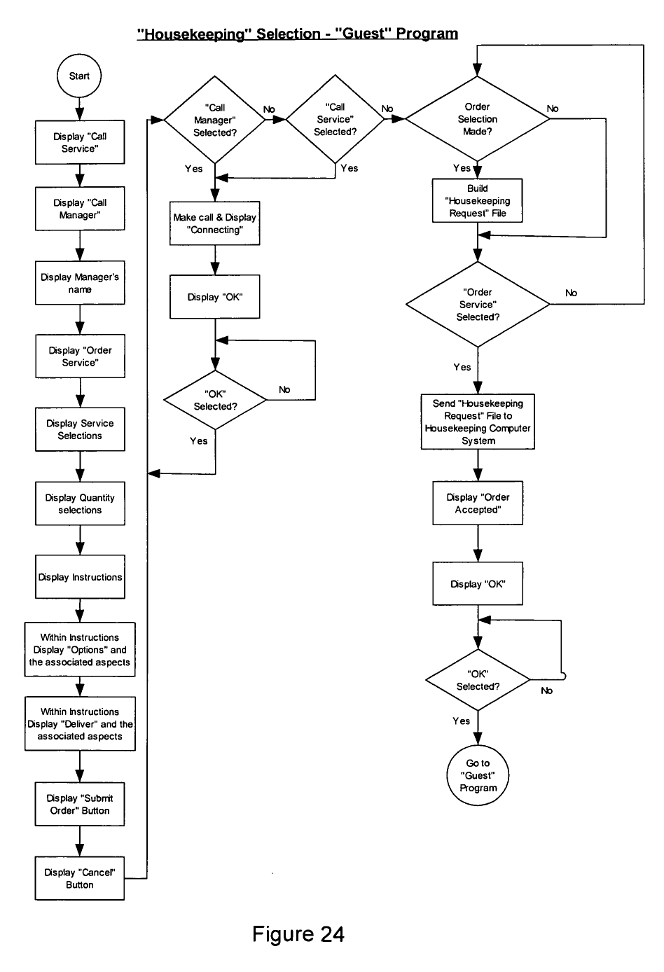

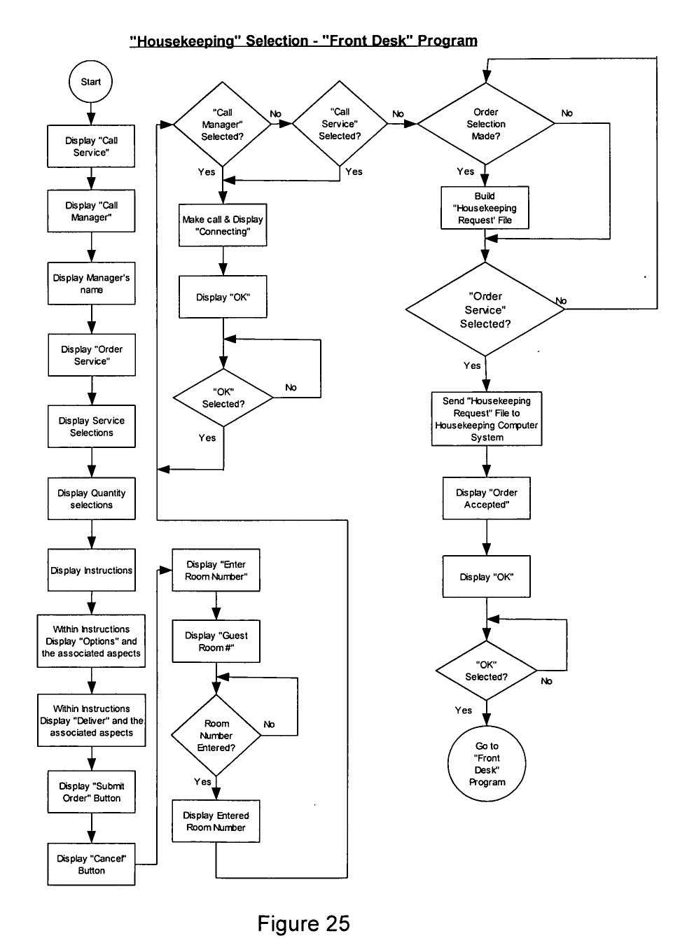

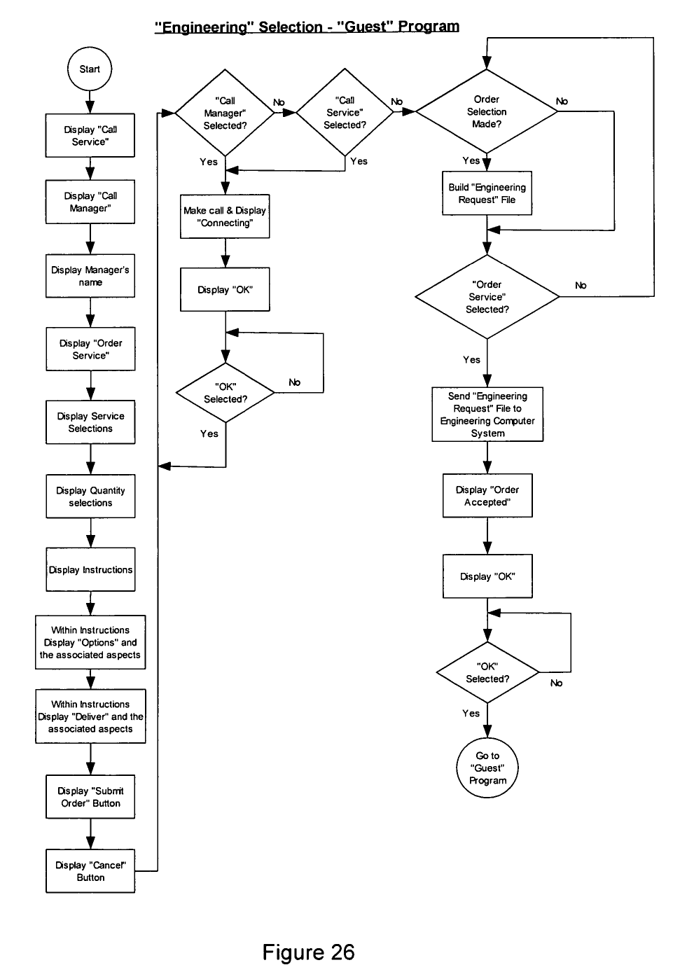

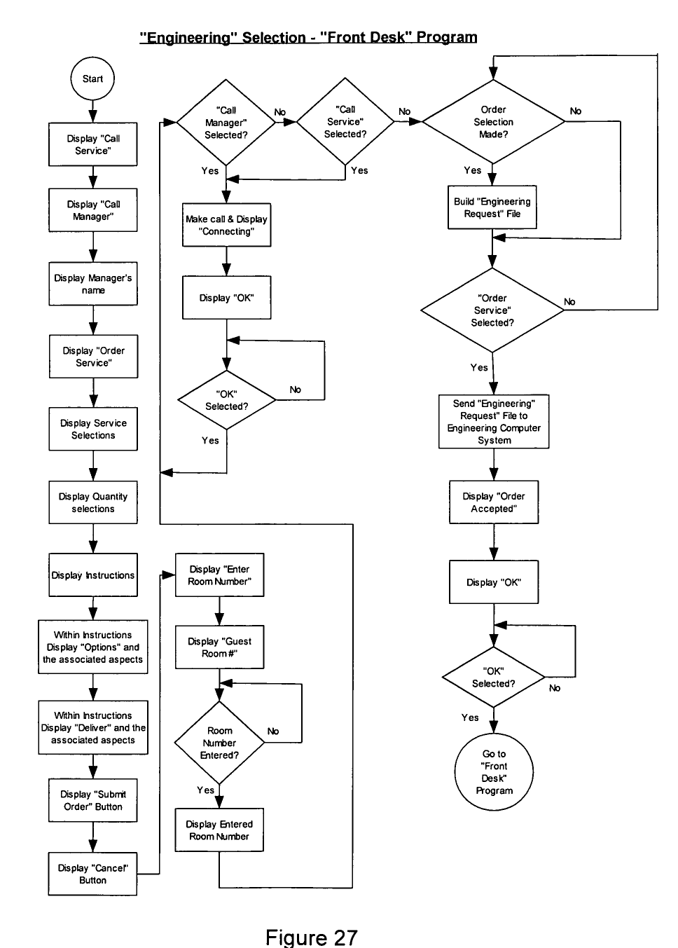

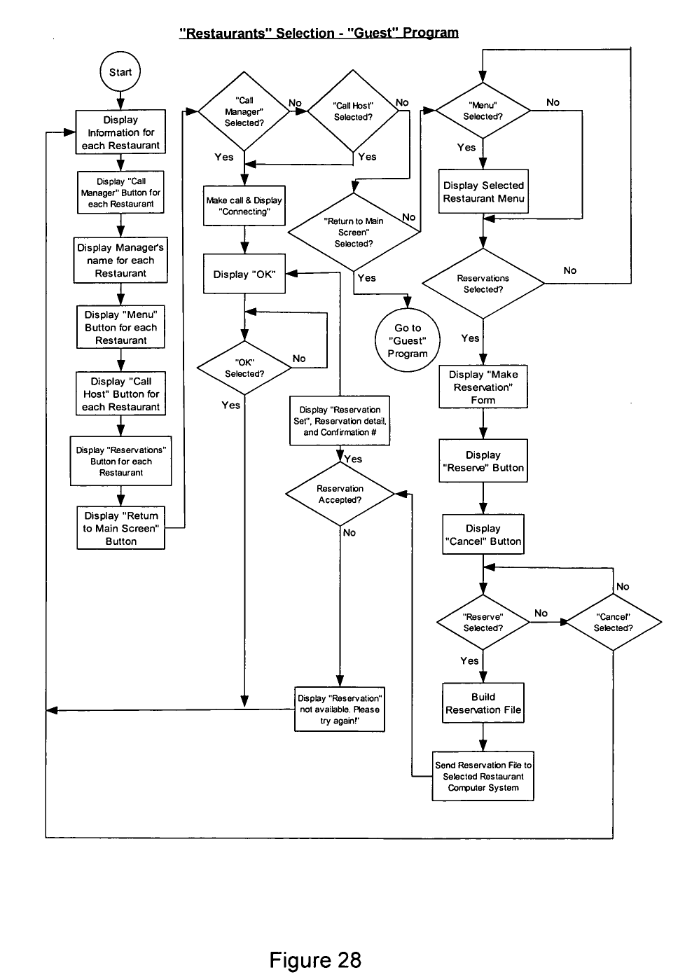

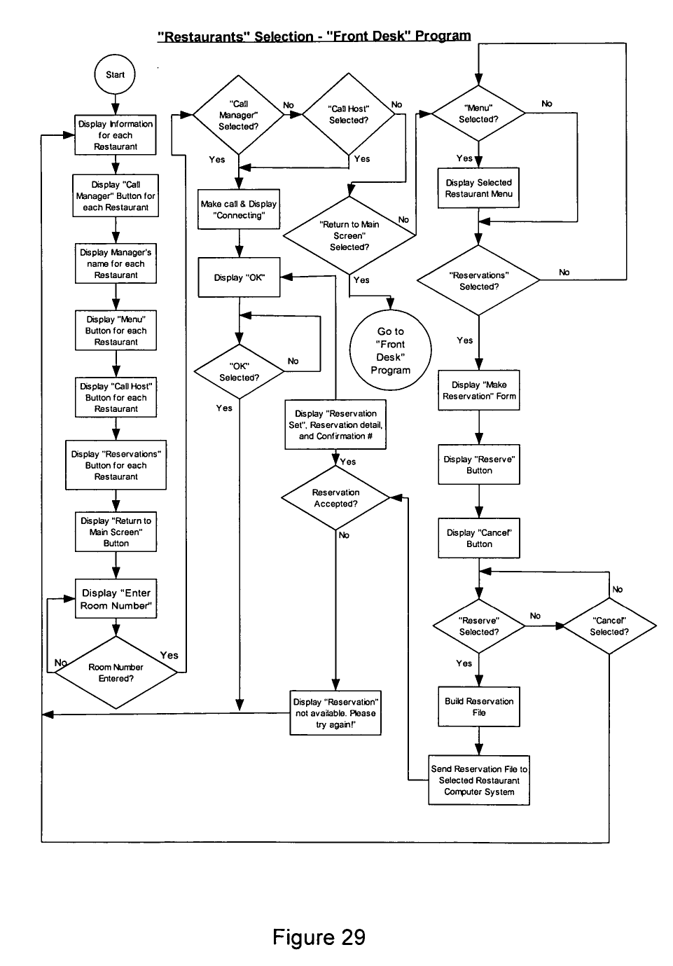

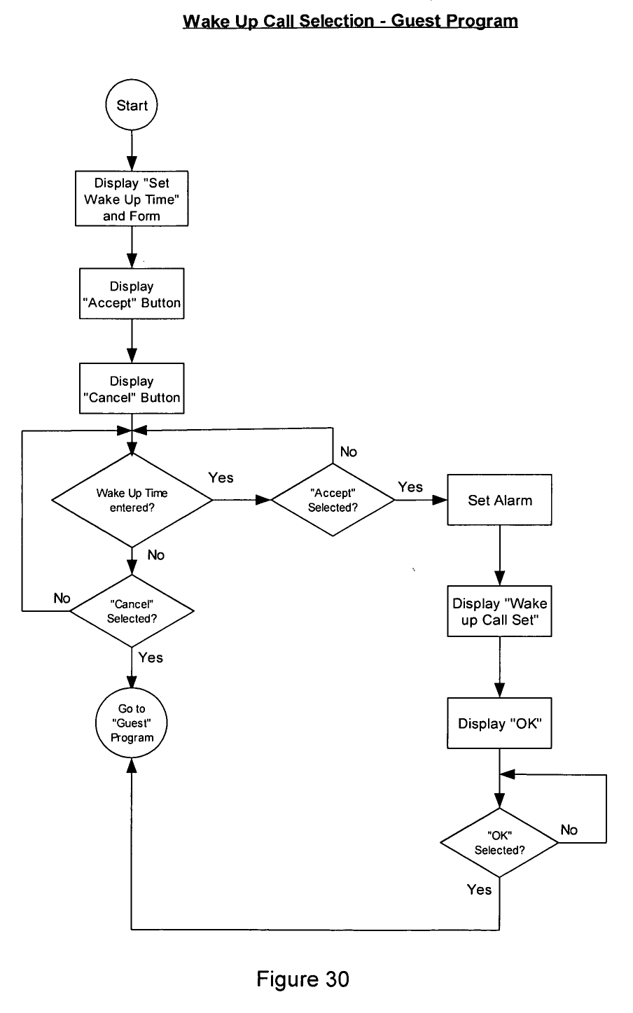

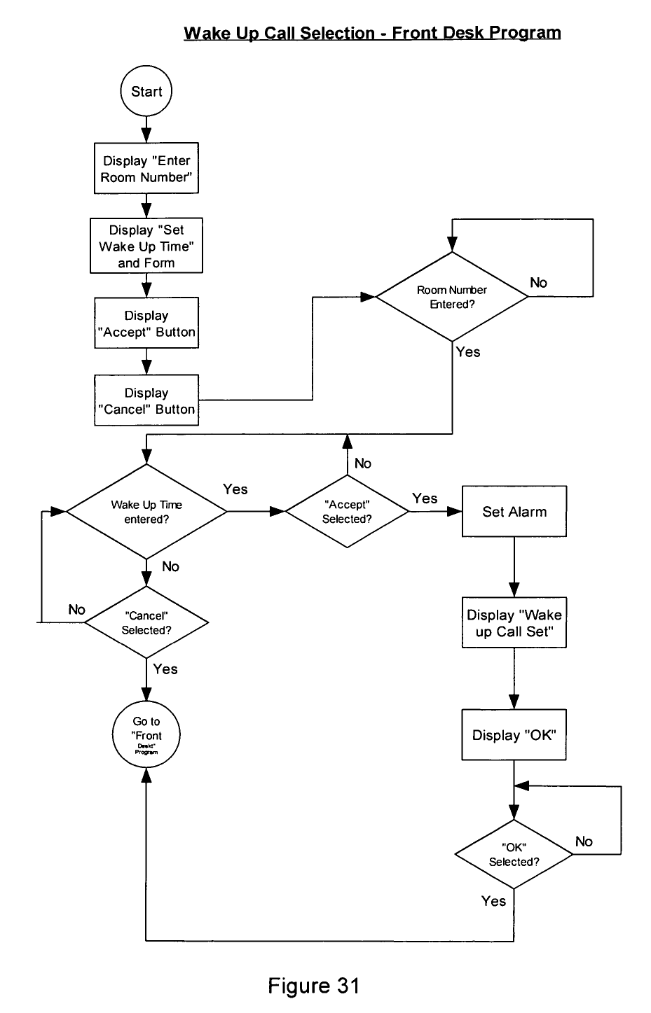

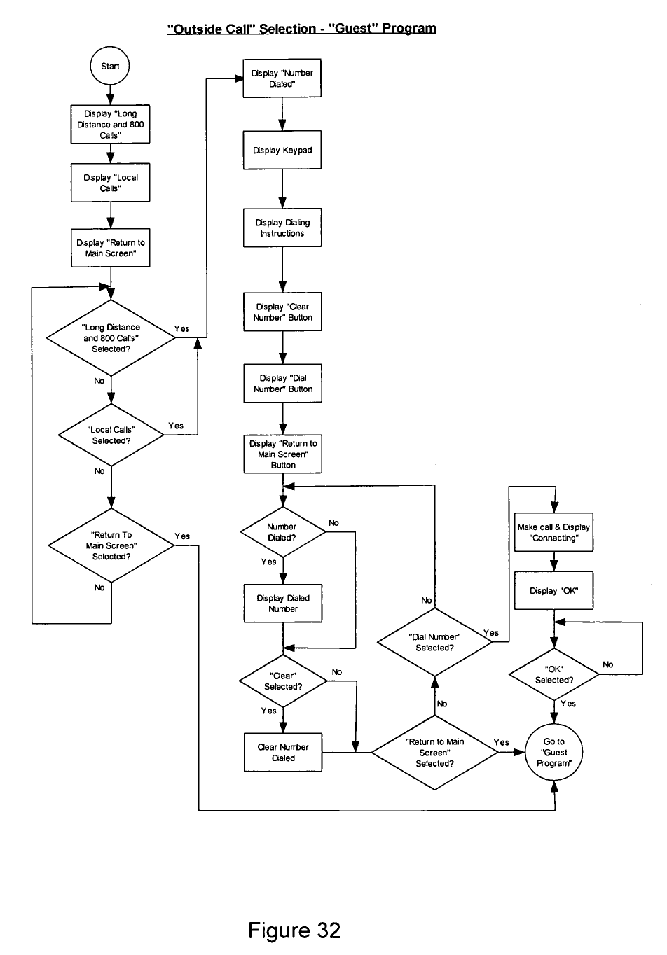

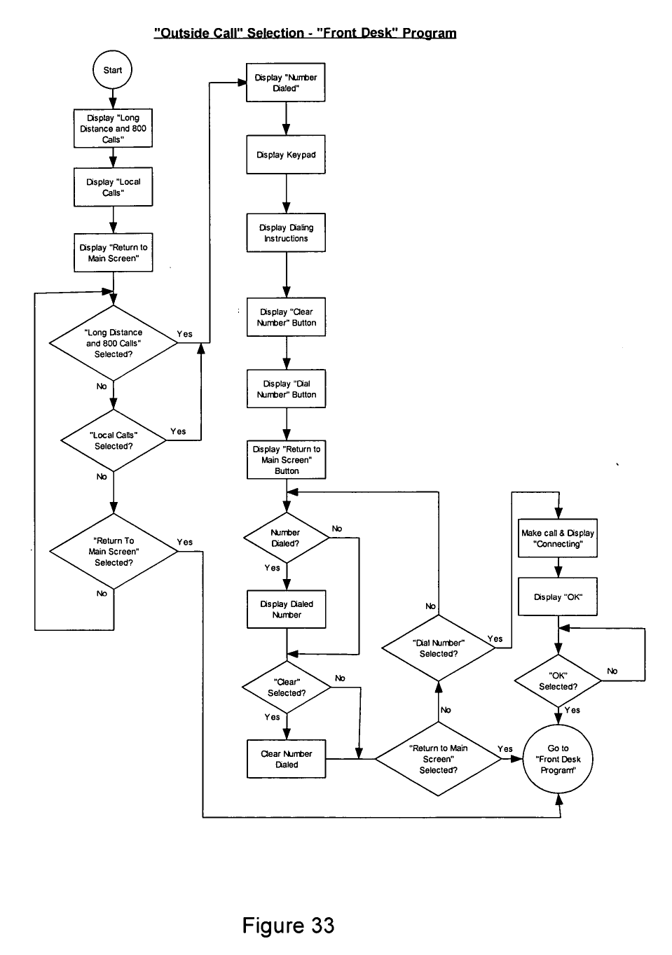

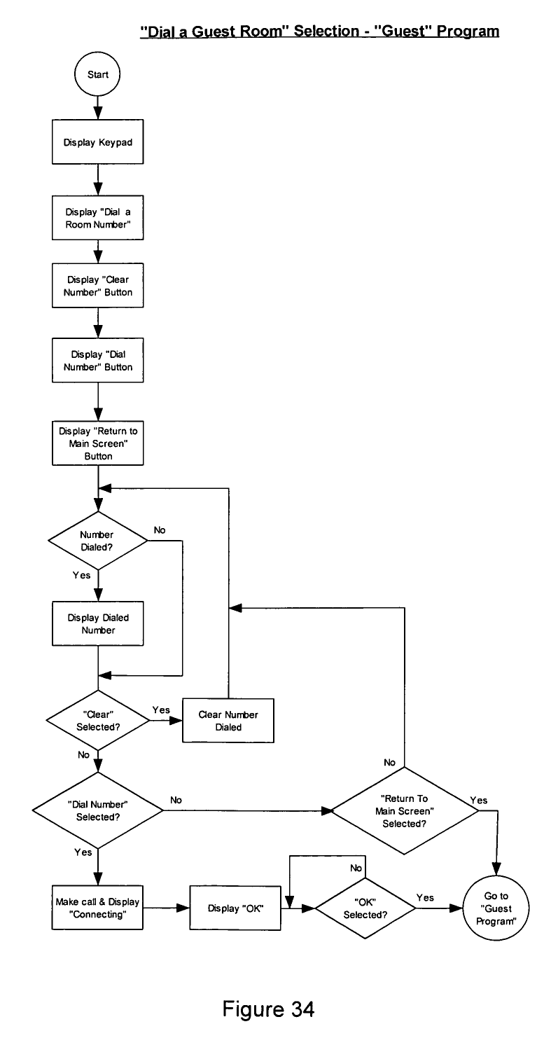

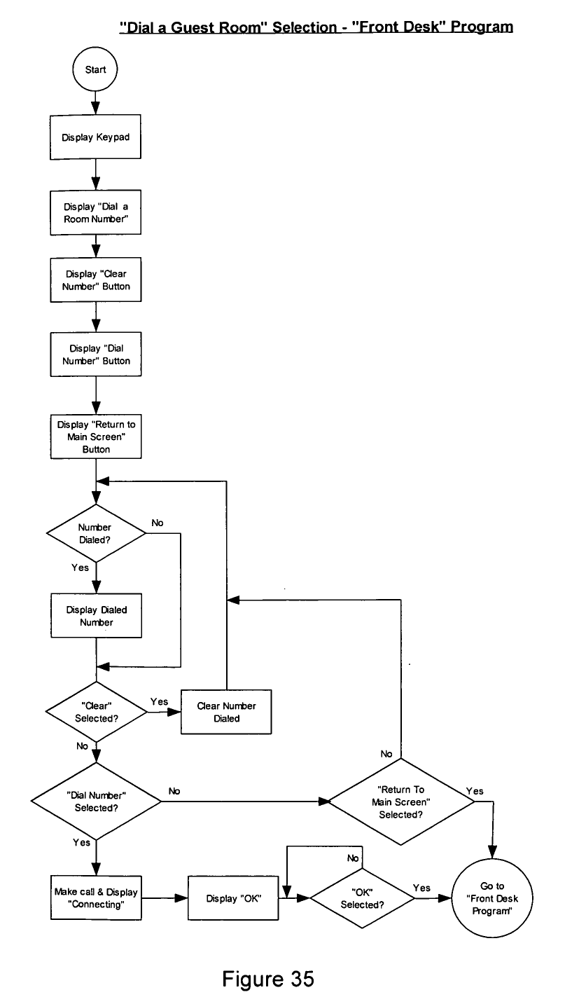

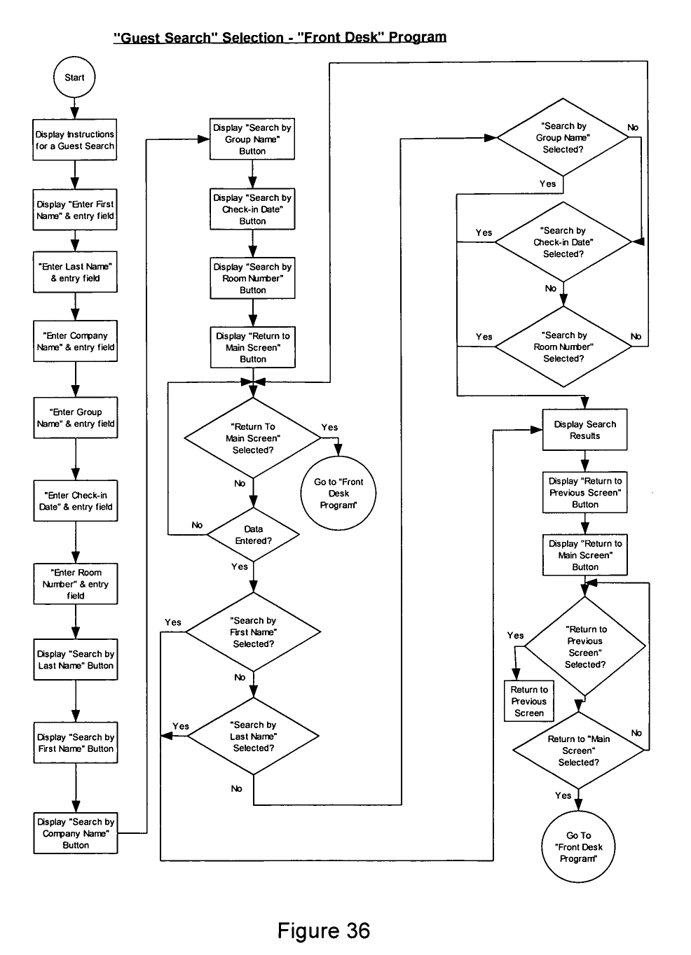

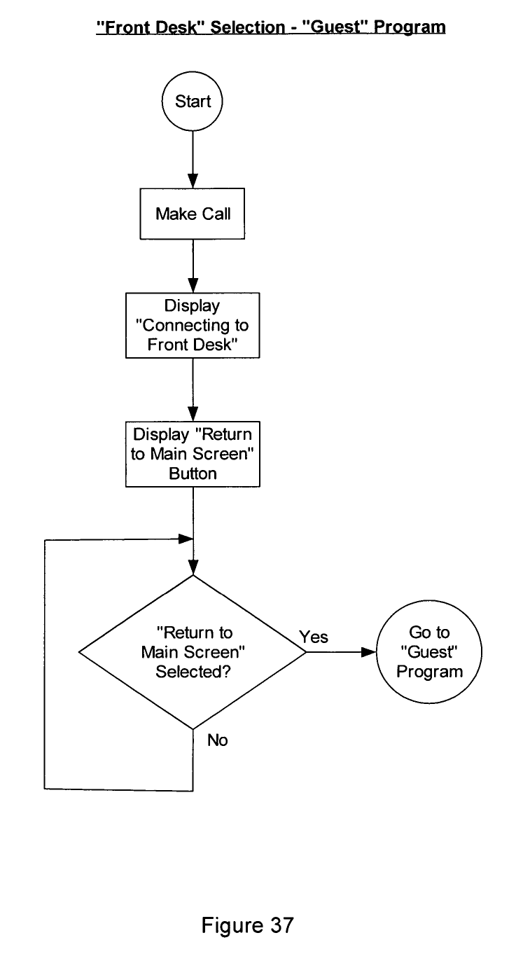

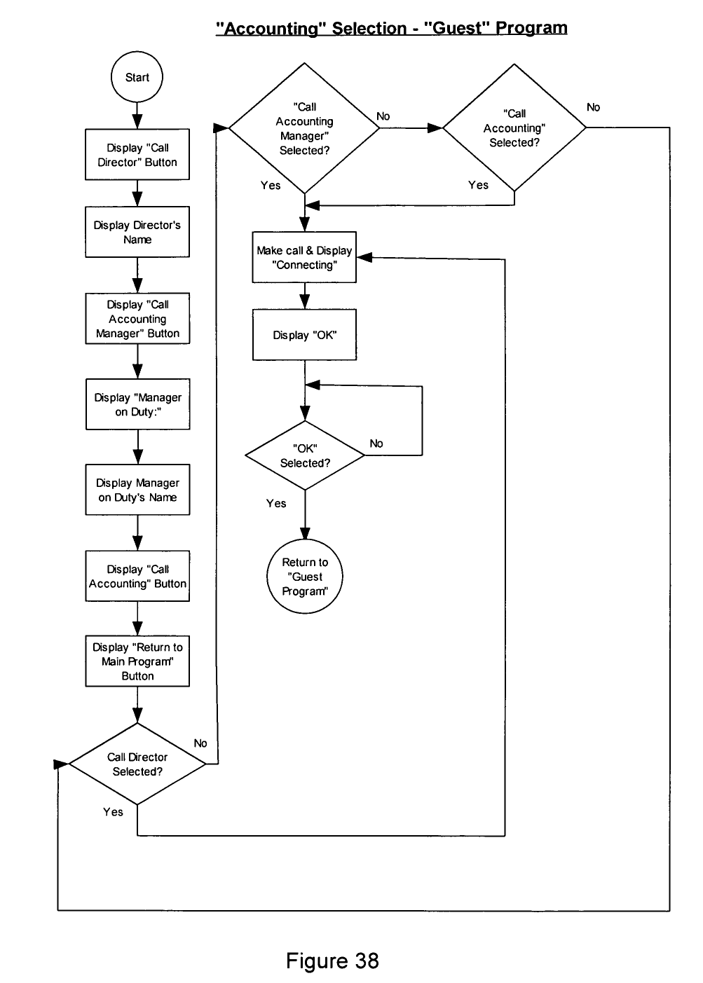

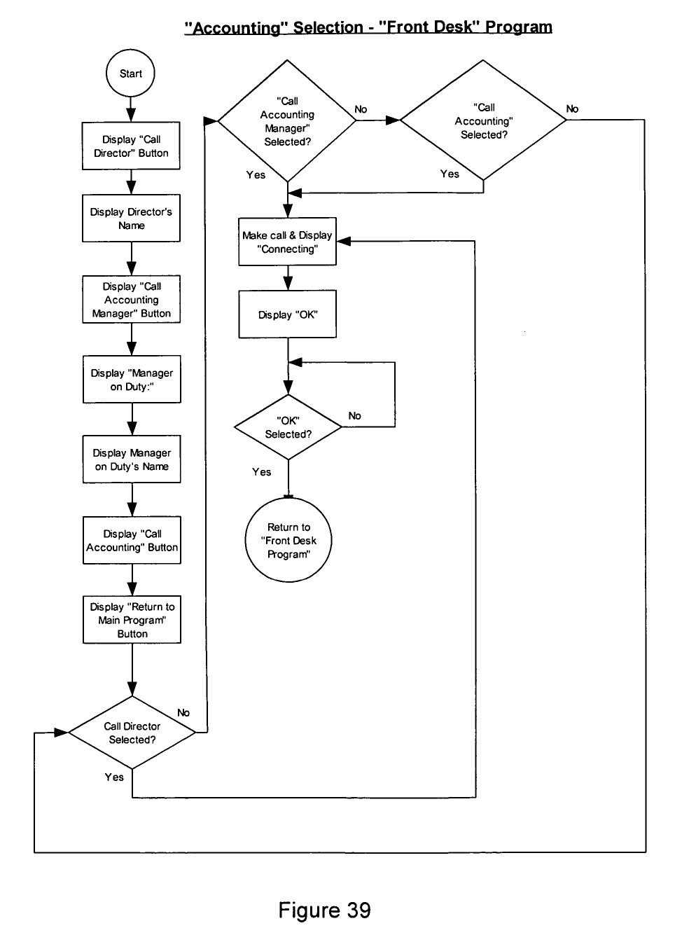

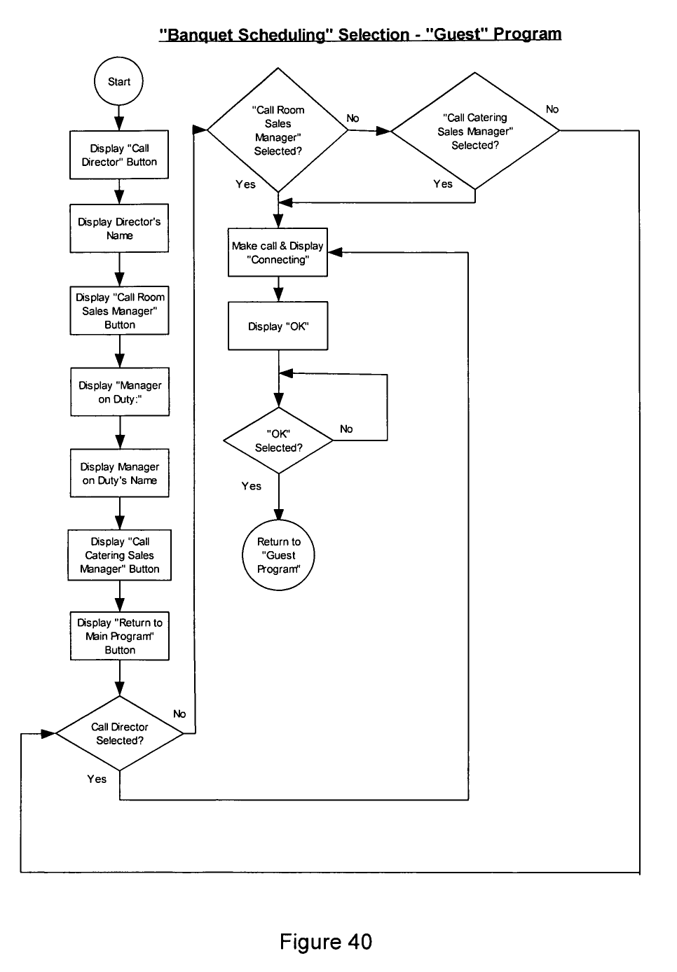

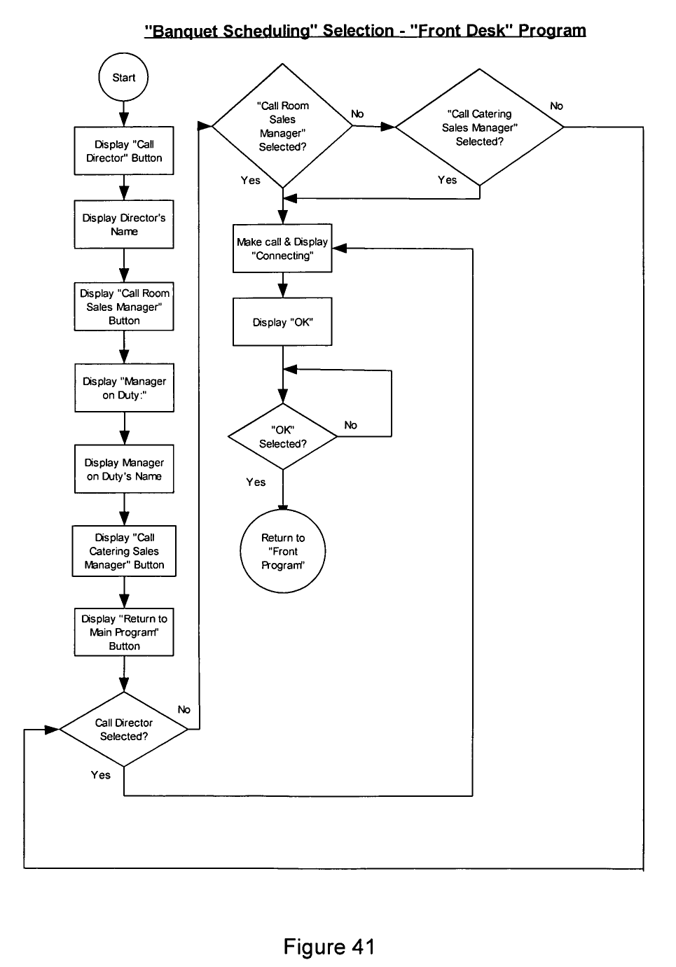

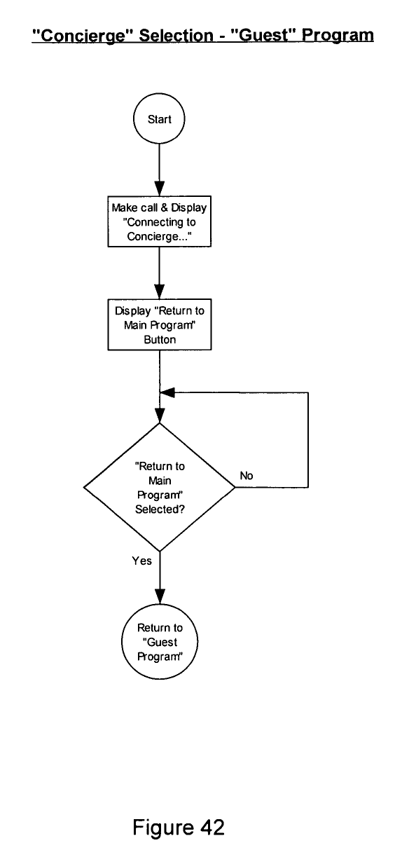

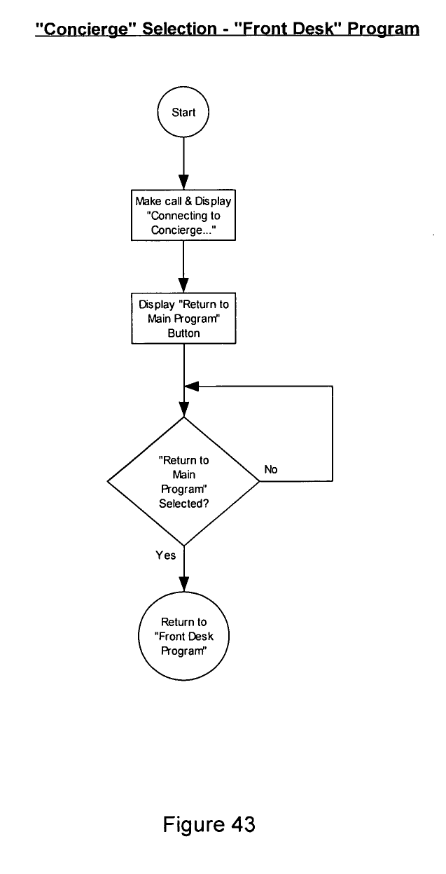

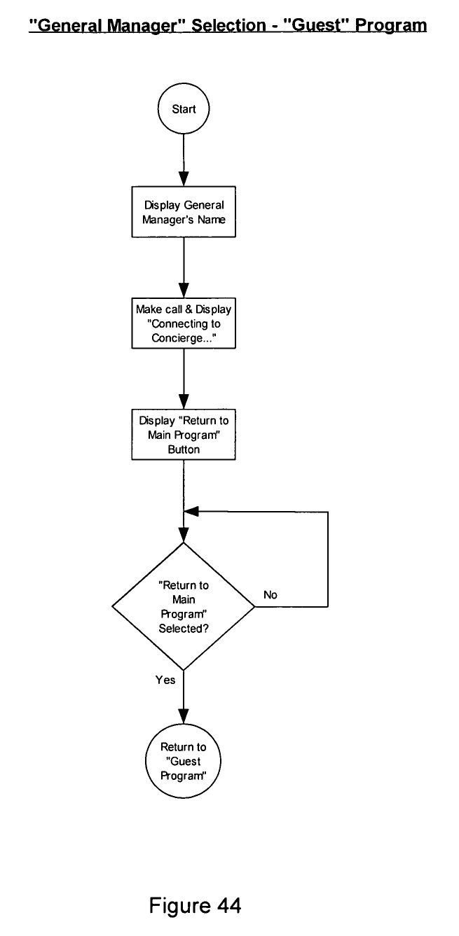

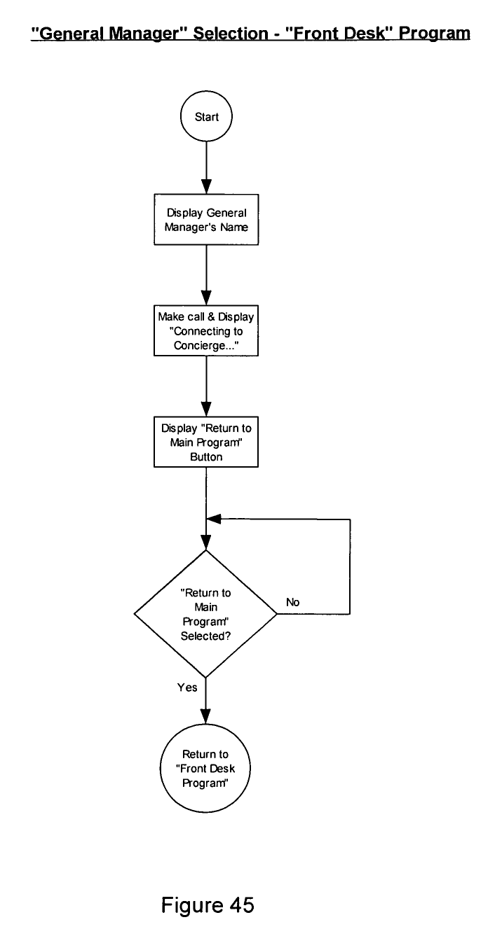

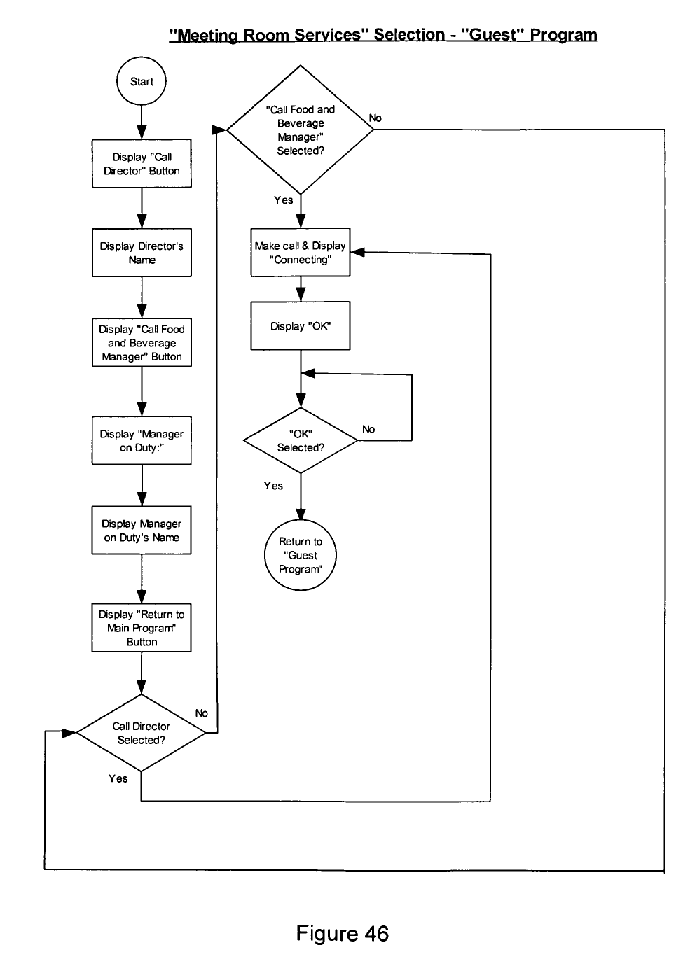

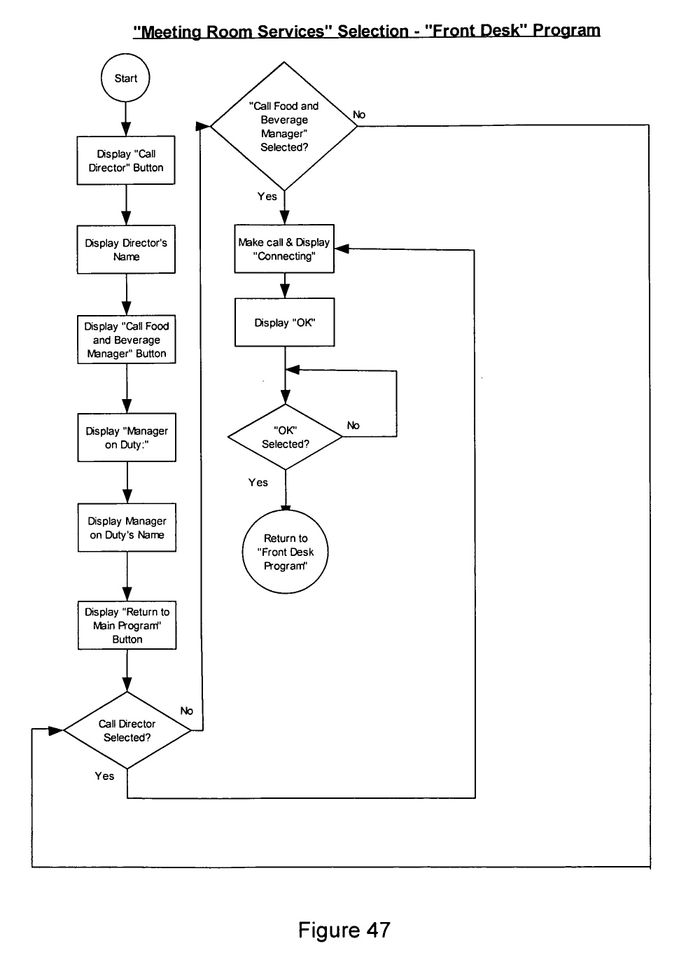

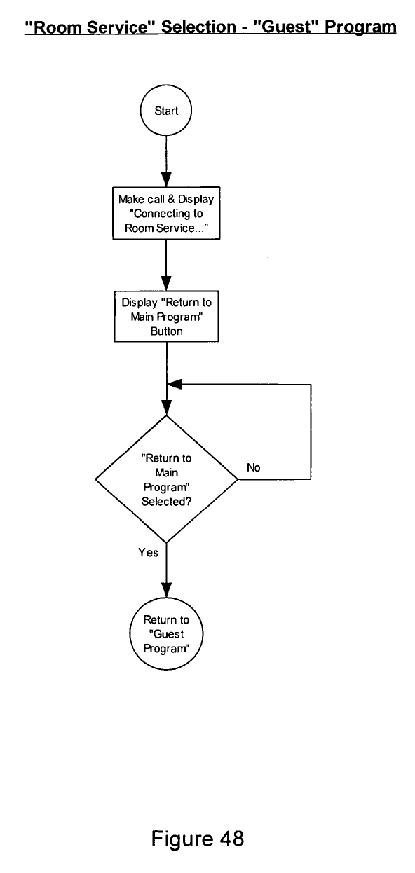

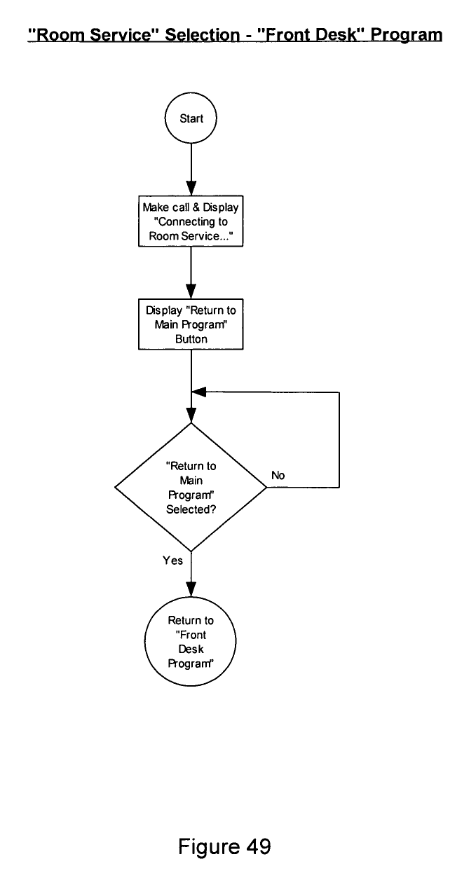

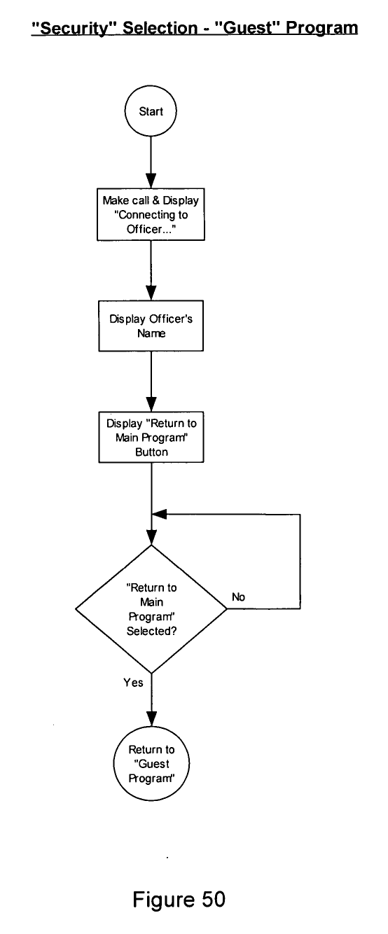

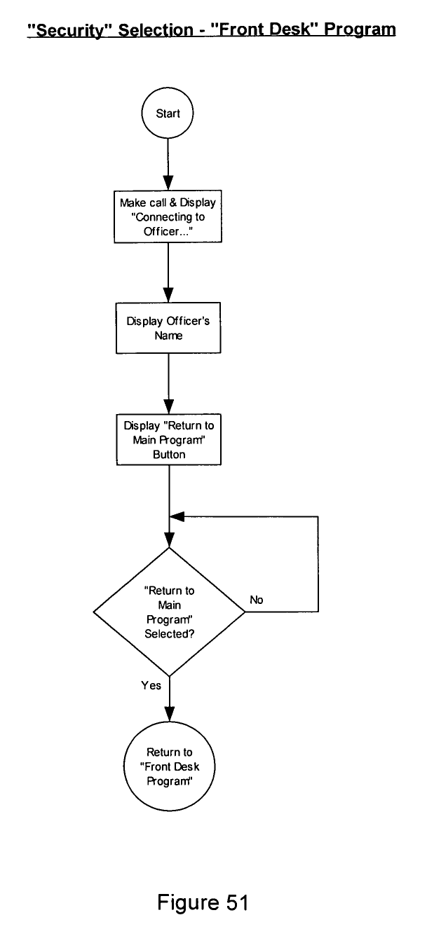

FIGS. 21-51 illustrate exemplary flow chart diagrams for operating the various components of software 121. The process for navigating the various flow chart diagrams is deemed to be self-explanatory. Therefore, the flow chart diagrams do not include reference numbers along with explanations for navigating through the various diagrams. One skilled in the art will readily appreciate that the invention may be performed using other techniques.

While the preferred forms of the invention have been disclosed, it will be apparent to those skilled in the art that various changes and modifications may be made that will achieve some of the advantages of the invention without departing from the spirit and scope of the invention. For example, the system may be configured to support a plurality of languages, among other features. It will be apparent to those reasonably skilled in the art that other components performing the same function may be suitably substituted. Further, the methods of the invention may be achieved in either all software implementations, using the appropriate processor instructions, or in hybrid implementations that utilize a combination of hardware logic and software logic to achieve the same results. Therefore, the scope of the invention is to be determined solely by the appended claims.

We claim:

1. A hotel information and service system, comprising:
a server;
at least two client terminals that are in communication with the server;
an application that resides on the server or on the client terminals, wherein the application enables users to access hotel information and services;
a memory;
a graphical user interface that displays a plurality of icons that are associated with the hotel information and services, wherein the plurality of icons provide access to banquet scheduling information, concierge information, engineer information, front desk information, general manager information, housekeeping information, meeting room information, restaurant information, room service information, security information, wake up call information, telephone call information, hotel guest information, local events information or Internet access information; and
an input device that enables selection of the plurality of icons to retrieve hotel information and services or to place a request.

2. The system according to claim 1, wherein the at least two client terminals include a personal computer, a laptop, a smart terminal, a personal digital assistant, a cell phone, a web television system, a video game console, a kiosk, or a touch-sensitive screen.

3. The system according to claim 1, wherein the application comprises an authentication feature that validates an identity of a user.

4. The system according to claim 1, wherein the server comprises a presence feature that determines availability information associated with the client terminal.

5. The system according to claim 1, wherein the request is transmitted at least one client terminal.

6. The system according to claim 1, wherein the at least two client terminals further comprise a communication device.

7. The system according to claim 6, wherein the communication device enables a telephone call, email message, text message, or an instant message.

8. The system according to claim 1, wherein the memory stores data that is entered by a user and wherein the at least two client terminals are configured to transmit the data to the server upon an occurrence of an event.

9. The system according to claim 8, wherein the event includes connection of a corresponding client terminal to the server.

10. The system according to claim 1, wherein the at least one of the client terminals is configured to search a first name entry, a last name entry, a company name entry, a group name entry, a check-in date entry, or a room number entry.

11. A method of obtaining hotel information and services using a client terminal device, comprising:
associating the client terminal device with a hotel guest, wherein the association is performed using an authentication feature that validates an identify of the hotel guest;
enabling the hotel guest to access a graphical user interface that displays a plurality of icons that are associated with the hotel information and services;
enabling the hotel guest to select at least one icon;
presenting a second graphical user interface that includes a plurality of options;
enabling the hotel guest to select one or more of the plurality of options.

12. The method according to claim 11, wherein the plurality of icons provide access to banquet scheduling information, concierge information, engineer information, front desk information, general manager information, housekeeping information, meeting room information, restaurant information, room service information, security information, wake up call information, telephone call information, hotel guest information, local events information or Internet access information.

13. The method according to claim 11, further comprising enabling a telephone call, email message, text message, or an instant message.

14. The method according to claim 11, further comprising a second client terminal device and enabling the client terminal devices to communicate.
